(19) United States
(12) Patent Application Publication
(10) Pub. No.: US 2011/0200979 A1
(43) Pub. Date: Aug. 18, 2011

(54) Online instructional dialogs

(76) Inventors: Brian Benson, Tucson, AZ (US); John Robert Bergan, Tucson, AZ (US); Luke Ferris, Tucson, AZ (US); Michael Rattee, Tucson, AZ (US); Peter Guevara, Tucson, AZ (US)

(21) Appl. No.: 12/230,802

(22) Filed: Sep. 4, 2008

Related U.S. Application Data
(60) Provisional application No. 60/935,830, filed on Sep. 4, 2007.

(51) Int. Cl. G09B 5/00

(52) U.S. Cl. 434/350

(57) ABSTRACT

A system of online communications among students and the teacher (“Dialogs”) within an educational management system, includes dialogs comprised of integration of online interactions between students and teachers, to be included in K-12 curriculum. Interactions may include lesson plans, assignments, benchmark and formative assessments. The system provides a permanent record of instruction indicating what has been taught and learned, and providing actionable information that can inform future instruction. The system has the ability to record the extent to which intervention has been implemented. Manual and automated scheduling of online interactions provide for real-time and asynchronous communications, and the ability to suspend interactions prior to completion.

### CROSS-REFERENCE TO RELATED APPLICATIONS

This application is related to U.S. Pat. Nos. 6,322,366, 6,468,085 and 7,065,516 and U.S. patent application Ser. No. 11/009,708, all of which patents and application are expressly incorporated in their entirety herein. This application claims benefit under 35 U.S.C. §119(e)(1) of U.S. Provisional Patent Application 60/935,830 which is expressly incorporated in their entirety herein. Additionally the disclosure in U.S. Published Patent Application 2003/00044762 is expressly incorporated in its entirety herein.

### BACKGROUND OF THE INVENTION

Educational instruction over the internet is commonly performed for college level students and teachers. Generally an instructor for a course creates online assignments and tests for students enrolled in the course, and the students receive credit for successfully completing the assignments and tests. Additionally lessons and tests have been developed for grades K-12 to be conducted on computers. However there is a need for improved online communications and instructional elements for teachers and students in the K-12 grades.

### BRIEF SUMMARY OF THE INVENTION

A system of online communications among students and the teacher (“Dialogs”) within an educational management system, includes dialogs comprised of integration of online interactions between students and teachers, to be included in K-12 curriculum. Interactions may include lesson plans, assignments, benchmark and formative assessments. The system provides a permanent record of instruction indicating what has been taught and learned, and providing actionable information that can inform future instruction. The system has the ability to record the extent to which intervention has been implemented. Manual and automated scheduling of online interactions provide for real-time and asynchronous communications, and the ability to suspend interactions prior to completion.

Furthermore there included an ability to construct, review, and modify elements of the dialog prior to scheduling for use in a learning environment along with the ability for a reviewer to require modification prior to approving the dialog under review.

Dialogs can be shared among a group of schools or districts (“Learning Communities”).

Multimedia resources and external links to information contained in dialogs may be attached.

Formative assessments, lesson plans, or assignments may be attached to a dialog at any user-determined location.

A dialog manager enables the user to specify the number of dialogs planned for time period for each standard to be covered during that time period.

### BRIEF DESCRIPTION OF THE DRAWINGS

FIGS. 1, 4, 7a, 7b, 14, 16, 21, 25, 28, 32a, 32b, 37, 46, 51, 56, 60, 64 and 69 are step diagrams setting forth the operation and construction of the item banking system for standards-based assessment of the present invention.

FIGS. 2, 3, 5, 6, 8, 9, 10, 11, 12, 13, 15, 17, 18, 19, 20, 22, 23, 24, 26, 27, 29, 30, 31, 33, 34, 35, 36, 38, 39, 40, 41, 42, 43, 44, 45, 47, 48, 49a, 49b, 50, 52, 53, 54, 55, 57, 58, 59, 61, 62, 63, 65, 66, 67, 68, 70, 71 and 72 are illustrations of computer screens of the item banking system for standards-based assessment of the present invention setting forth various steps the above step diagrams.

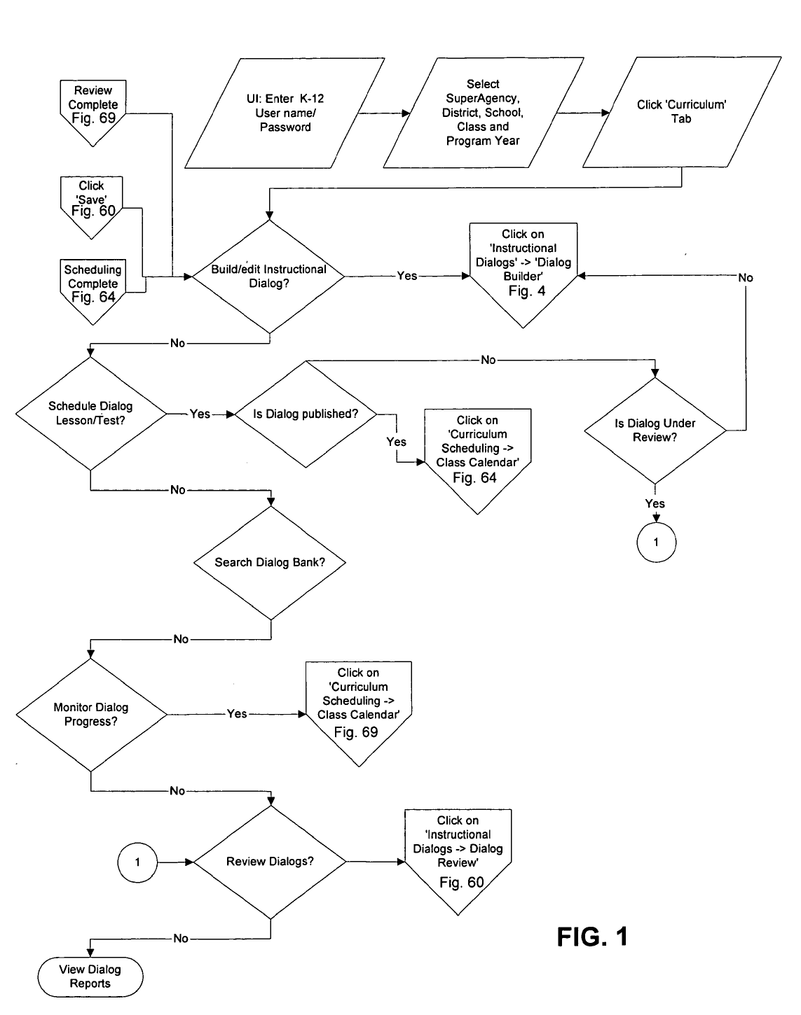

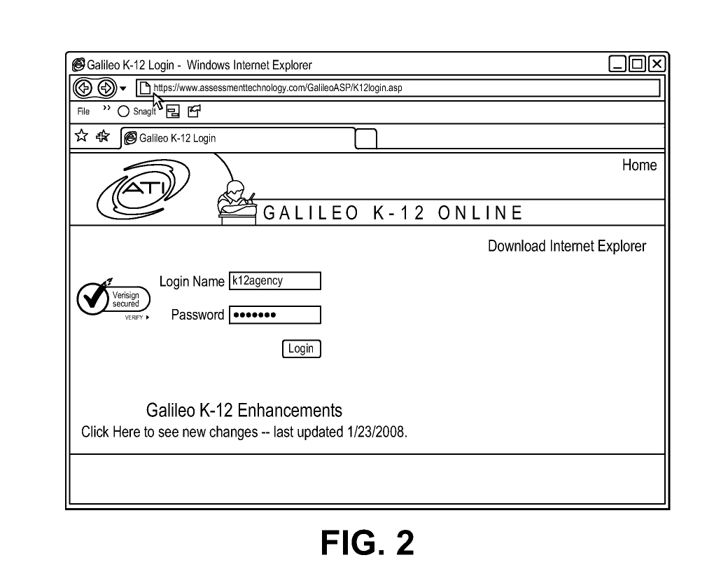

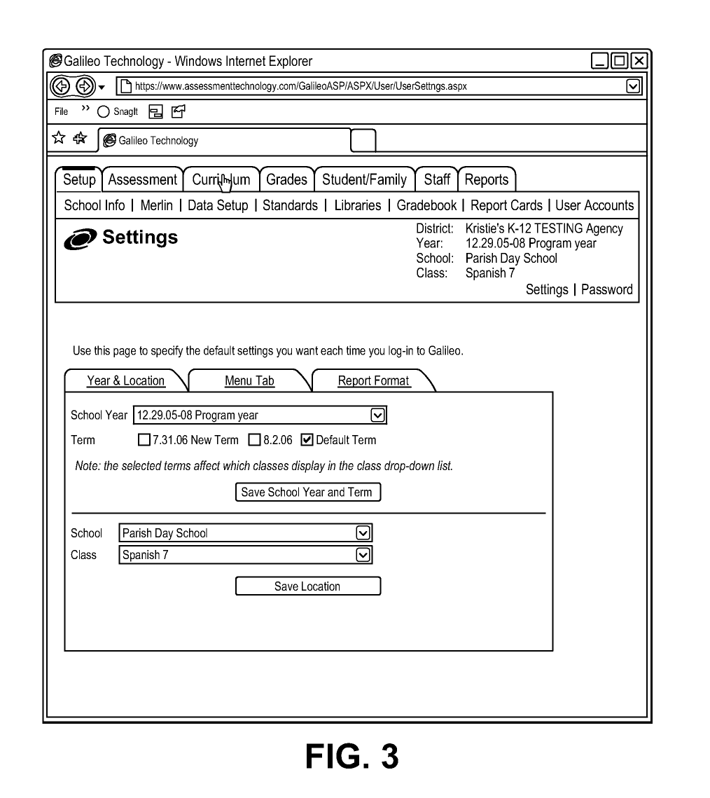

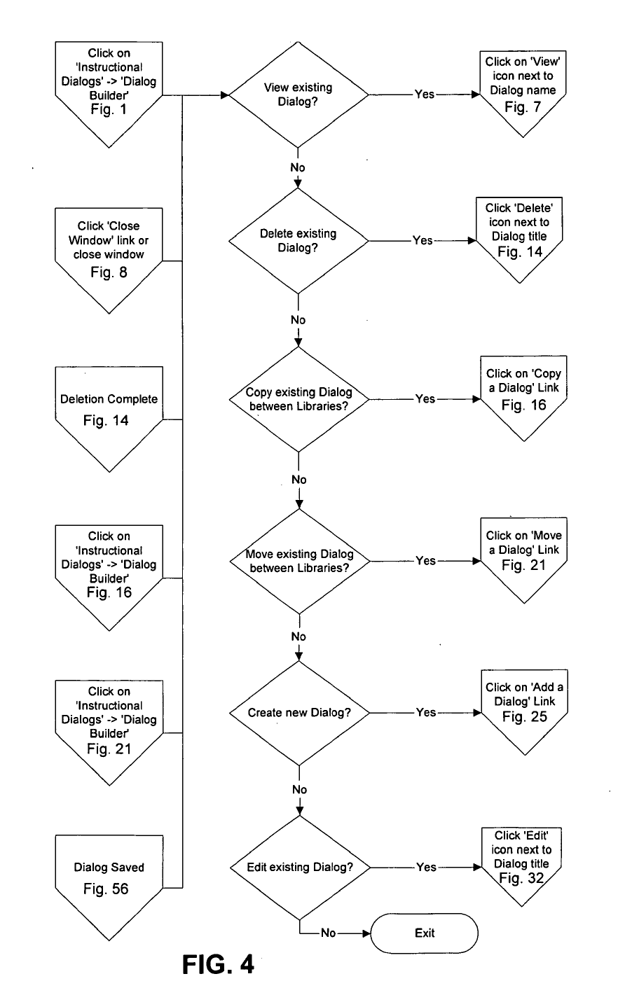

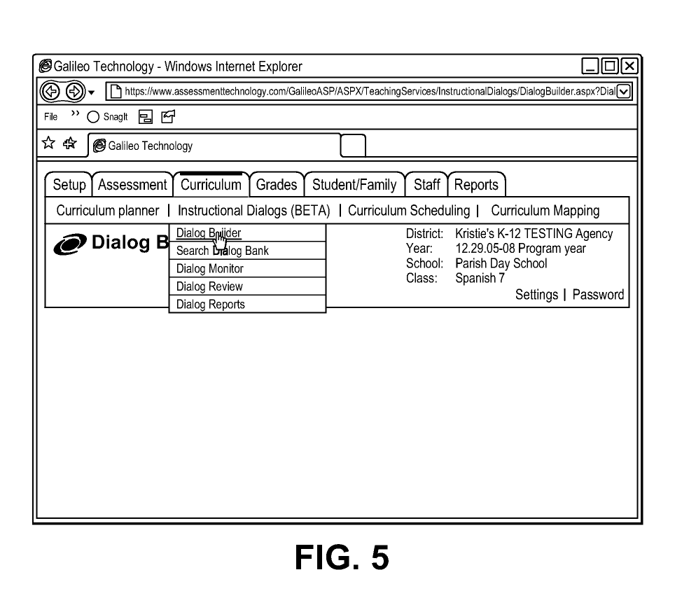

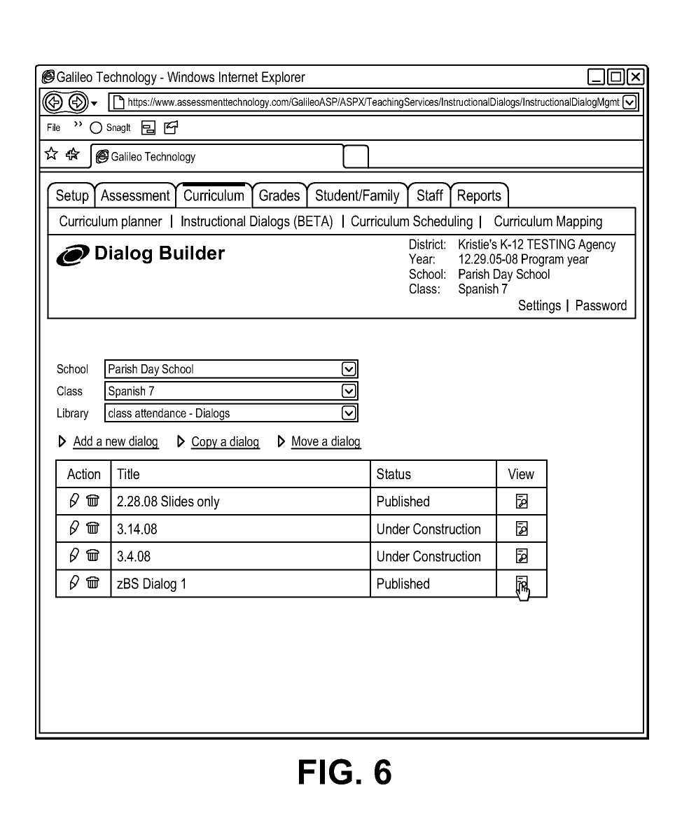

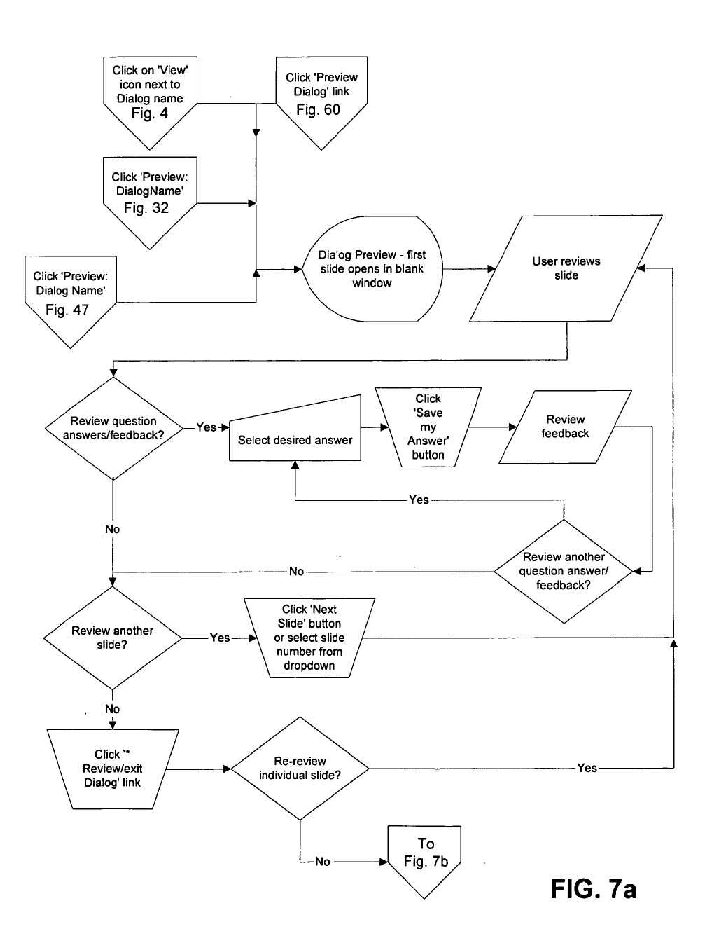

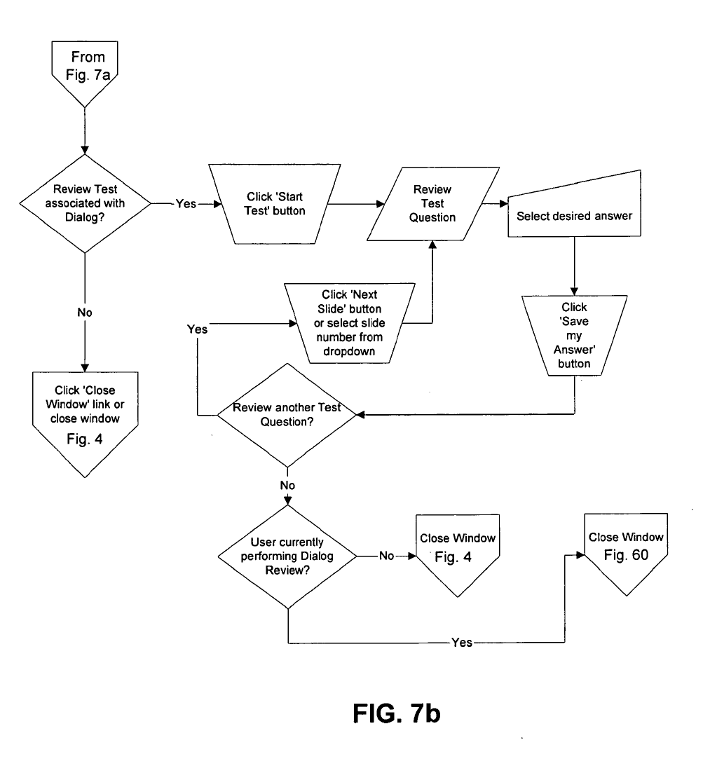

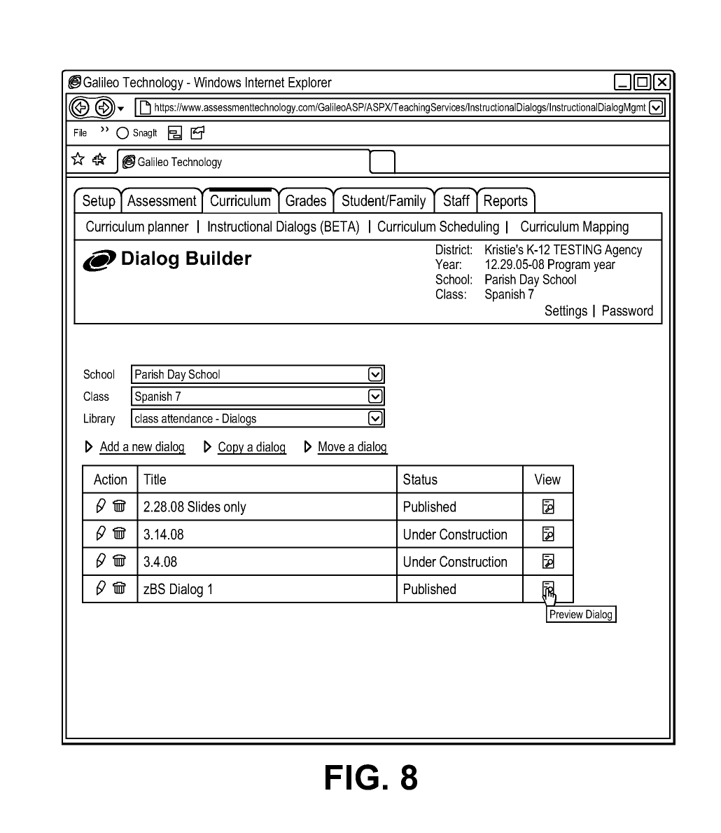

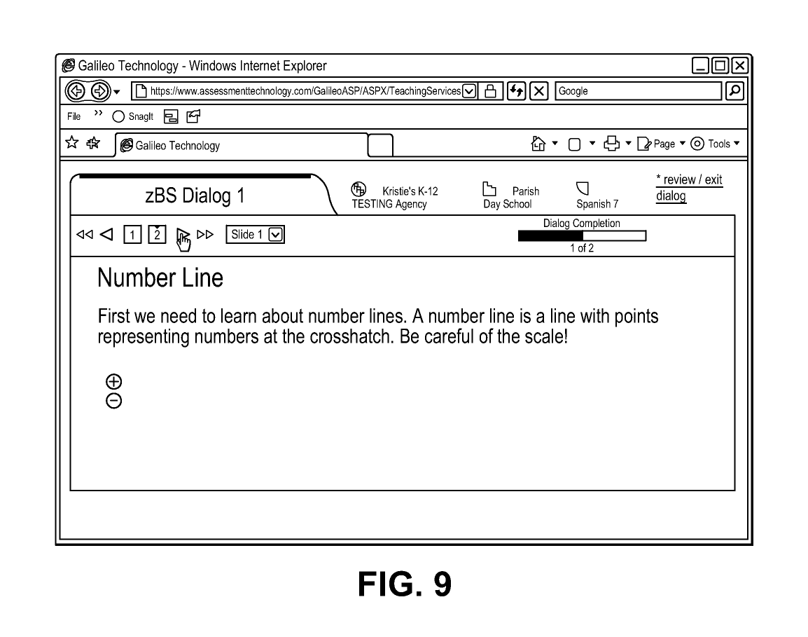

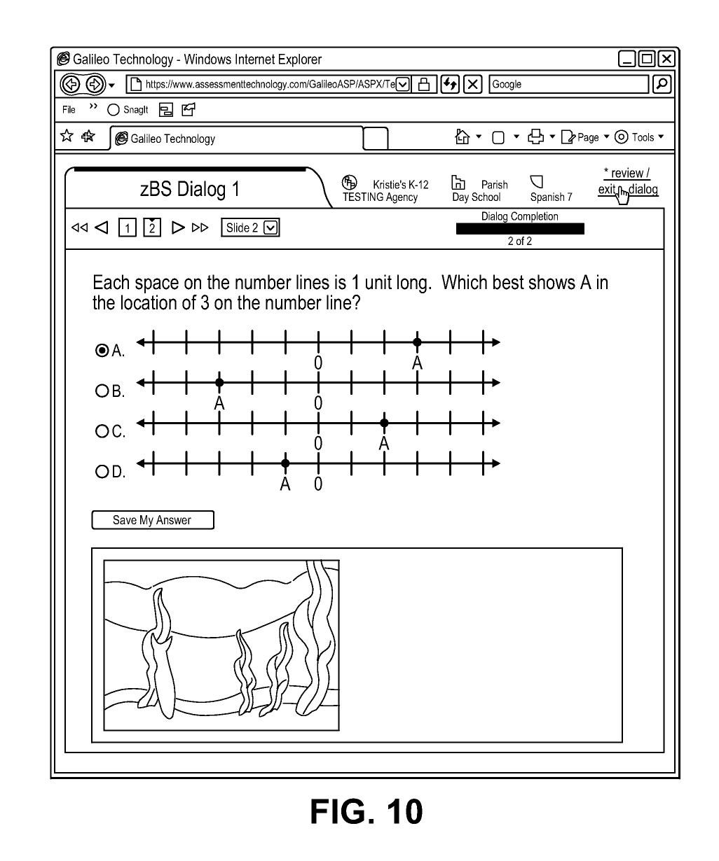

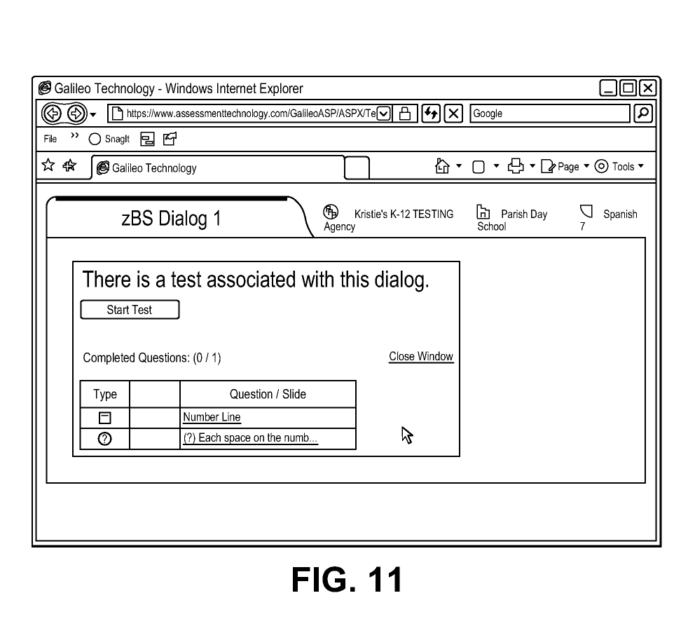

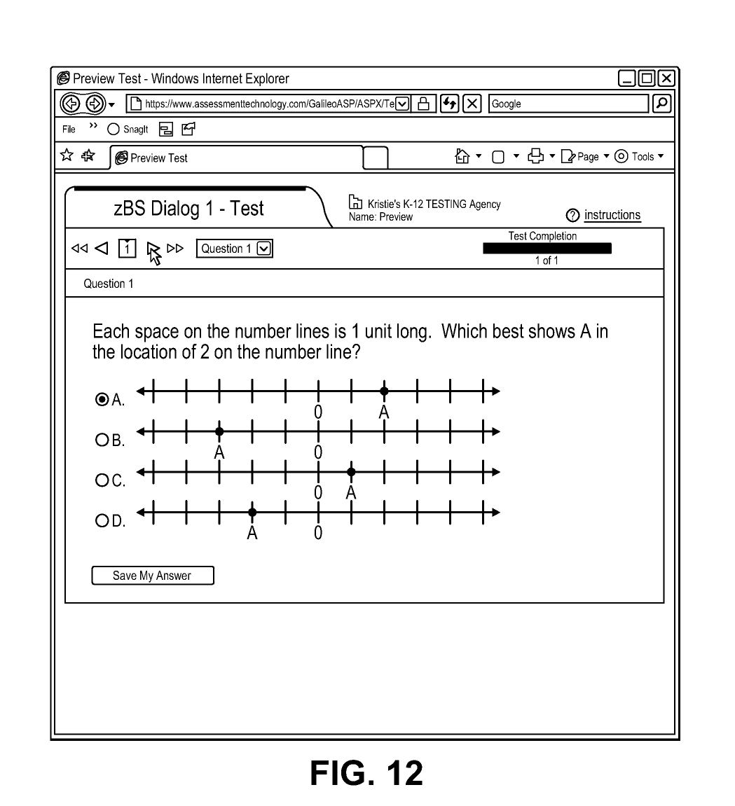

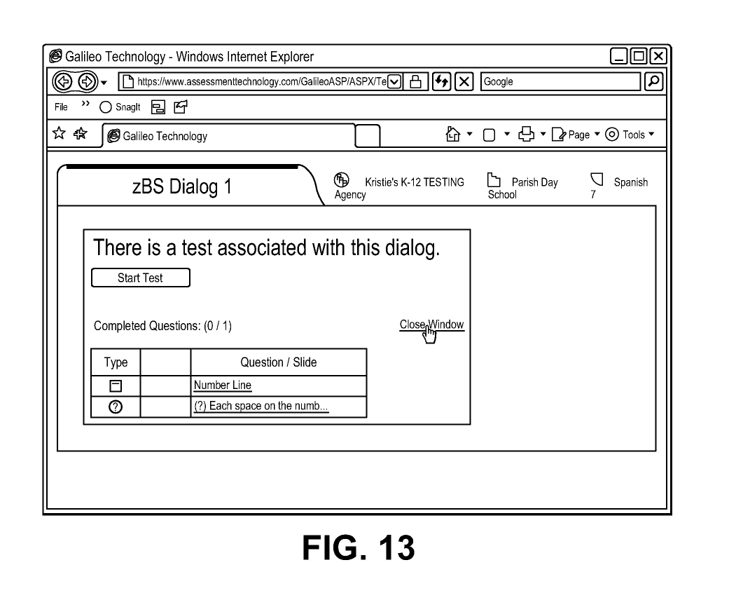

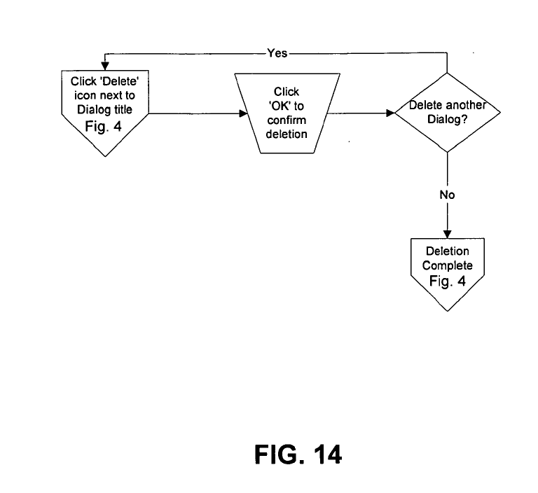

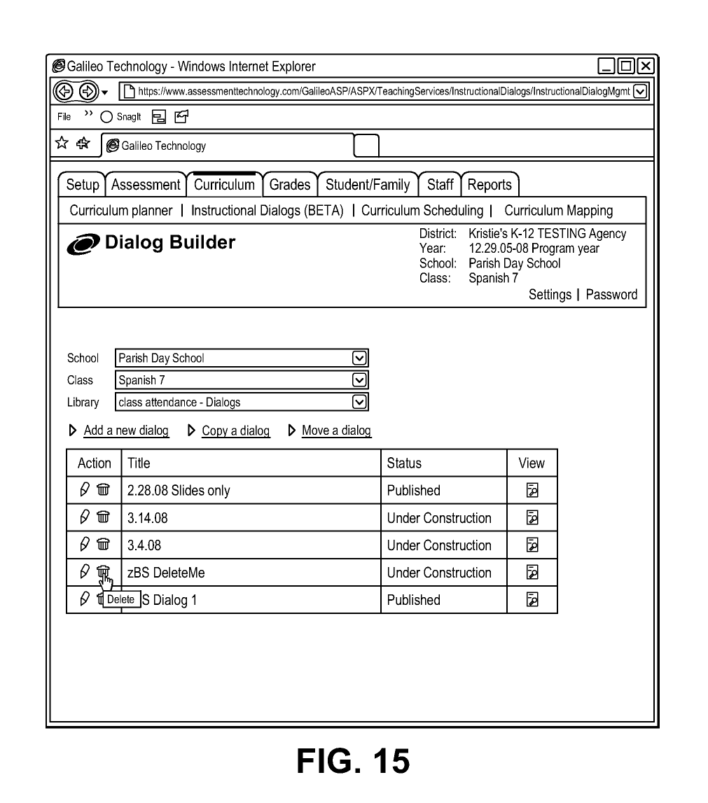

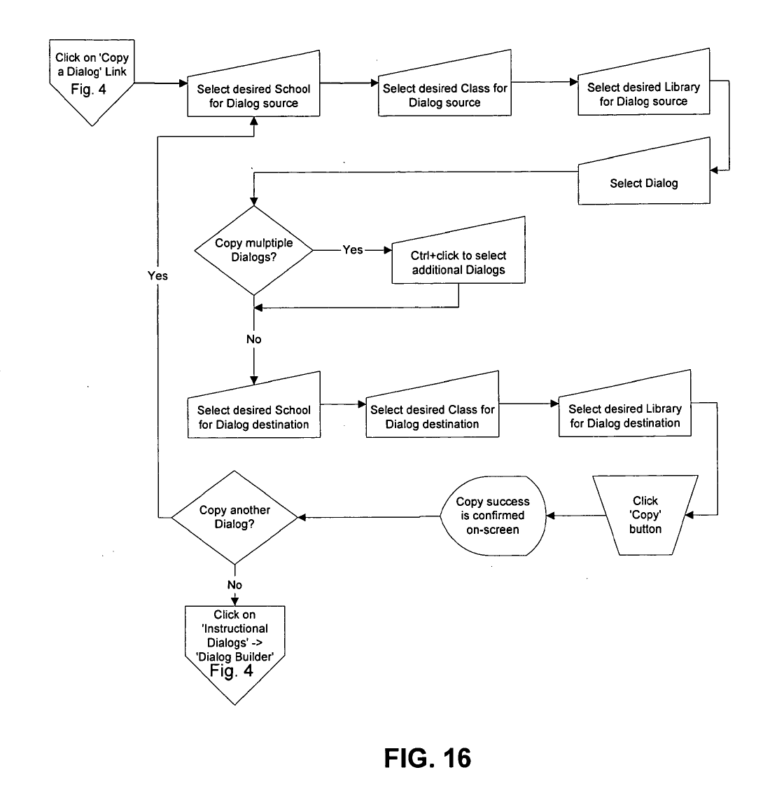

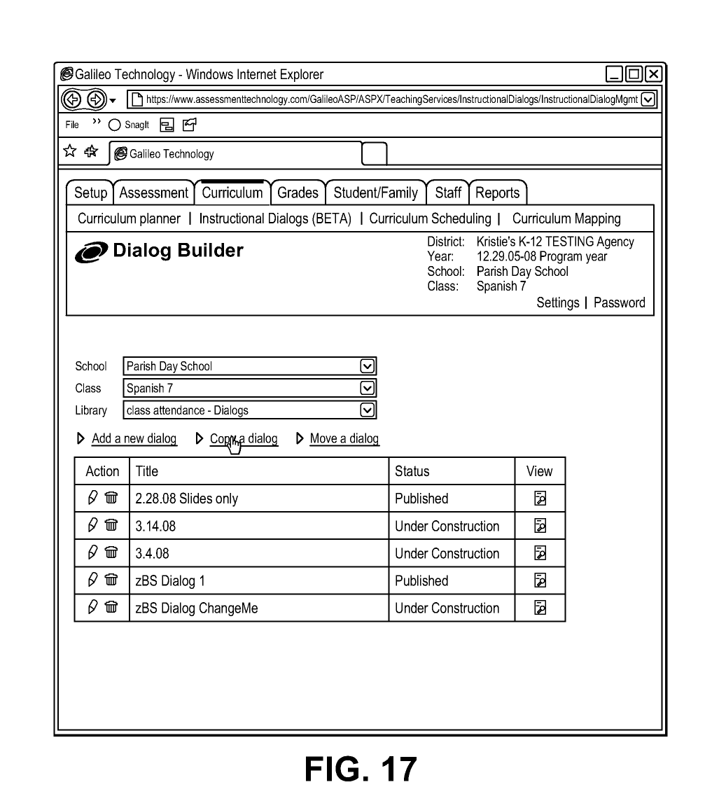

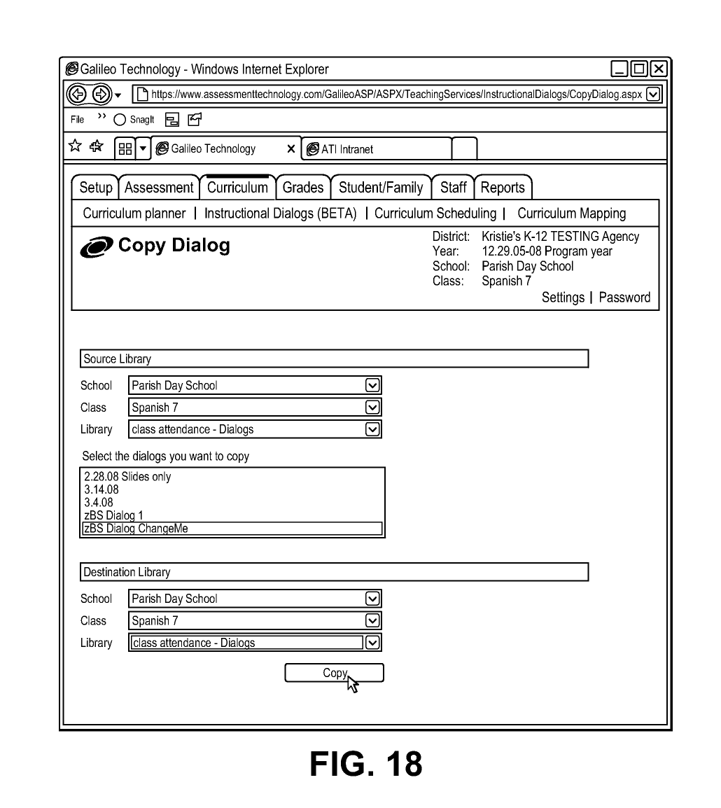

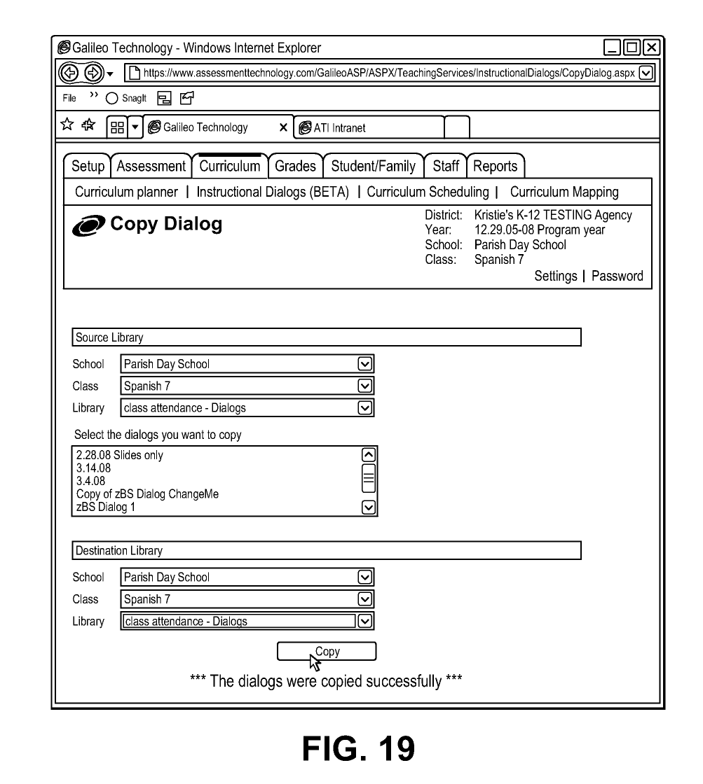

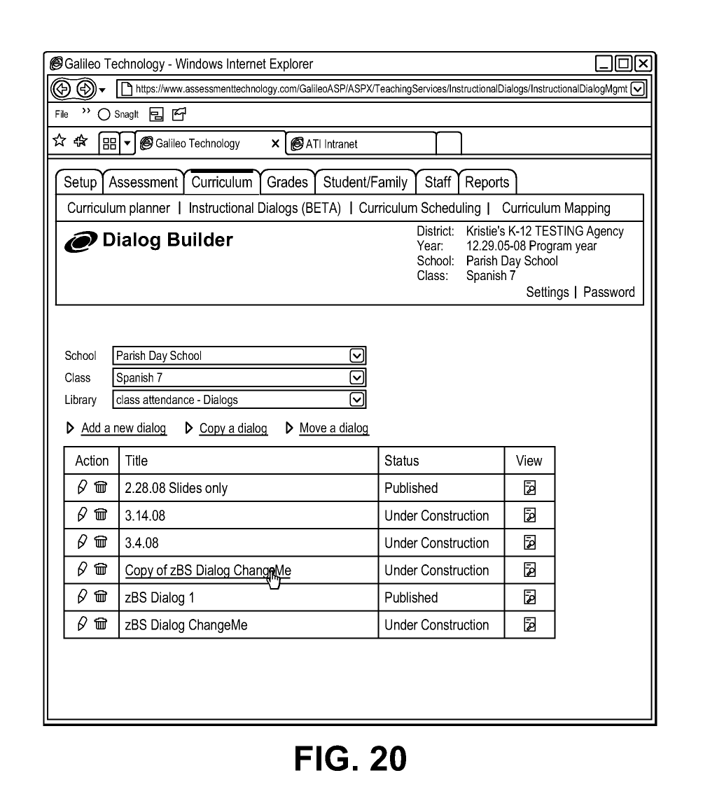

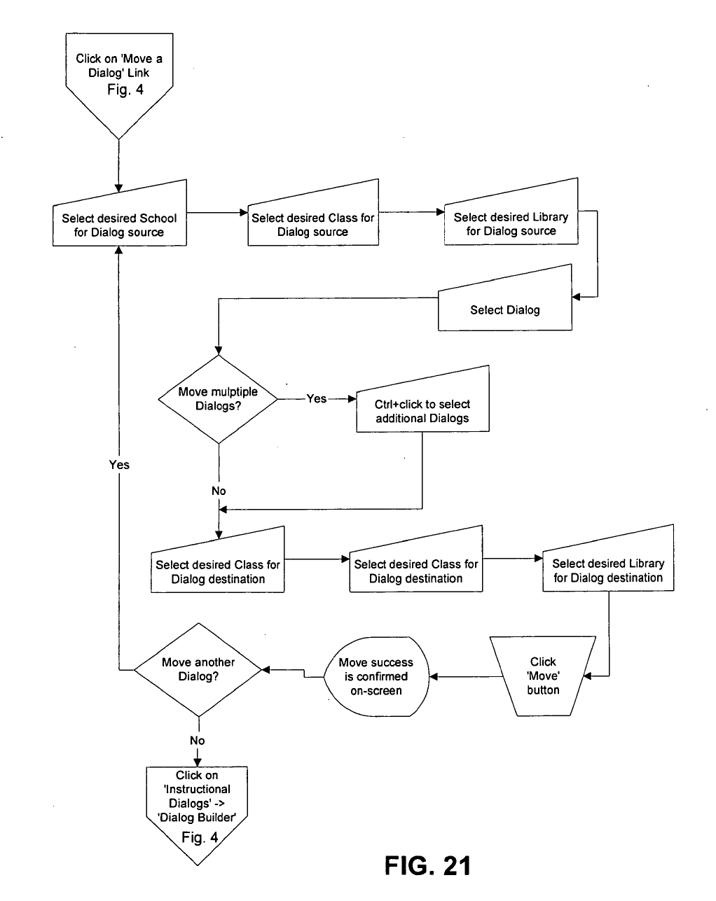

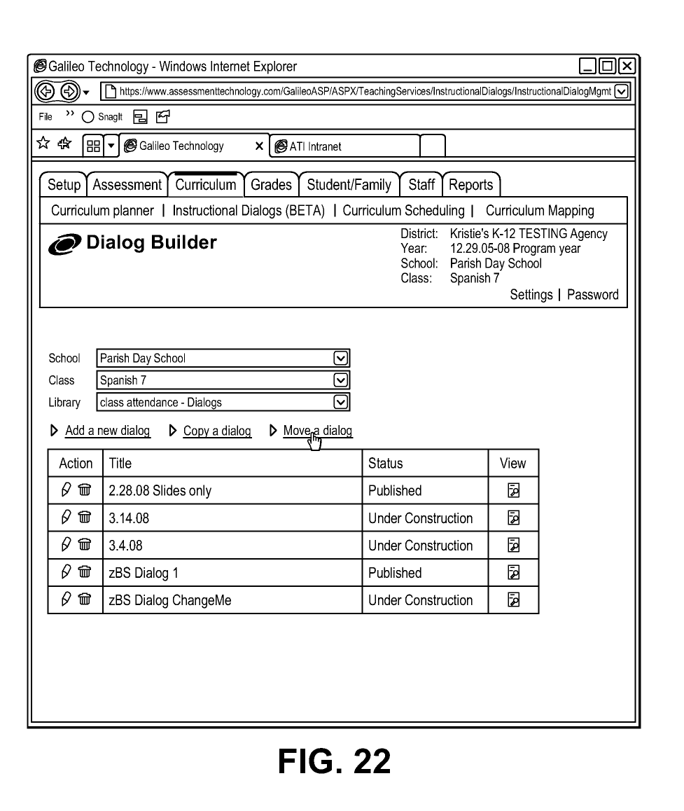

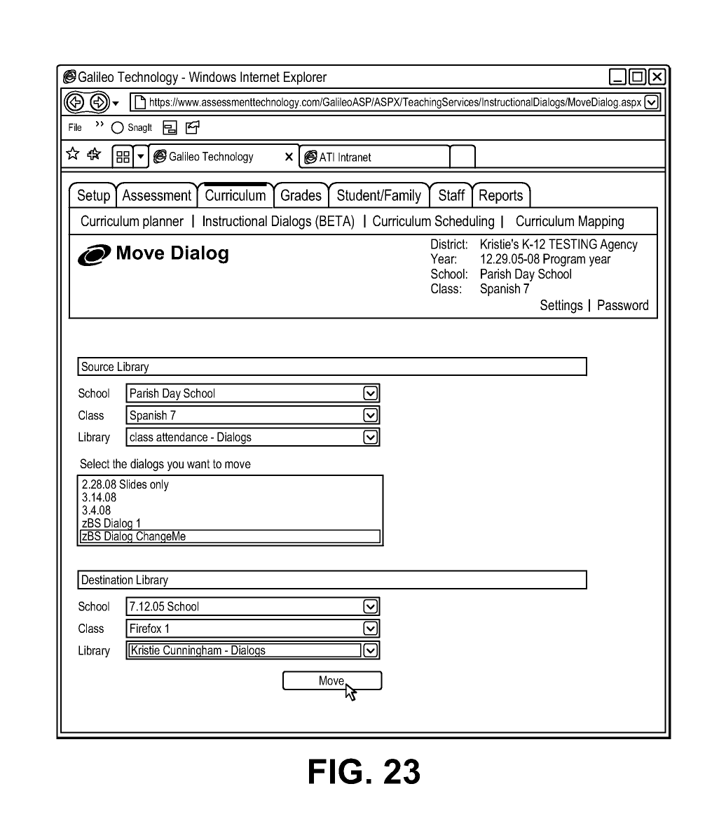

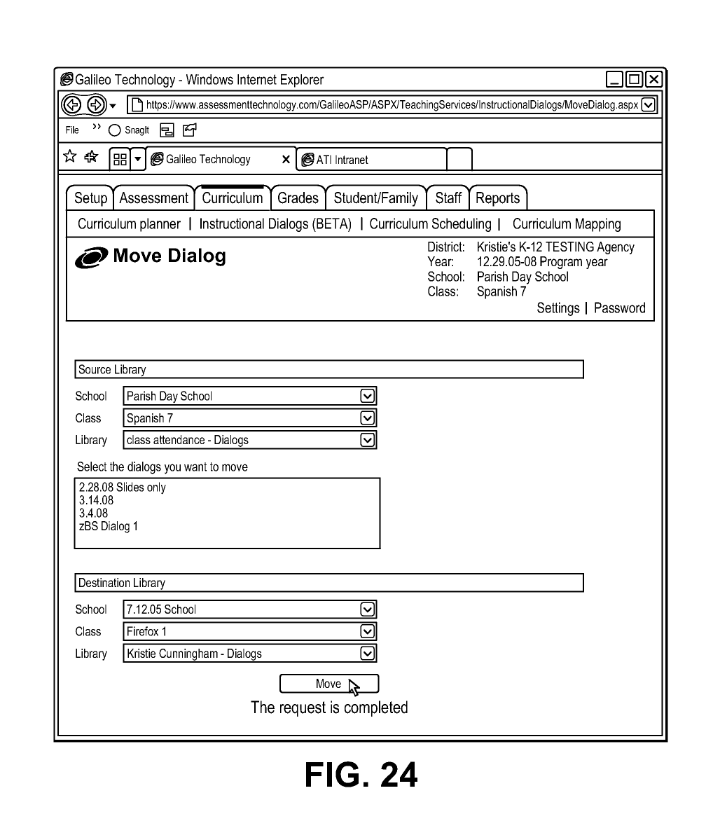

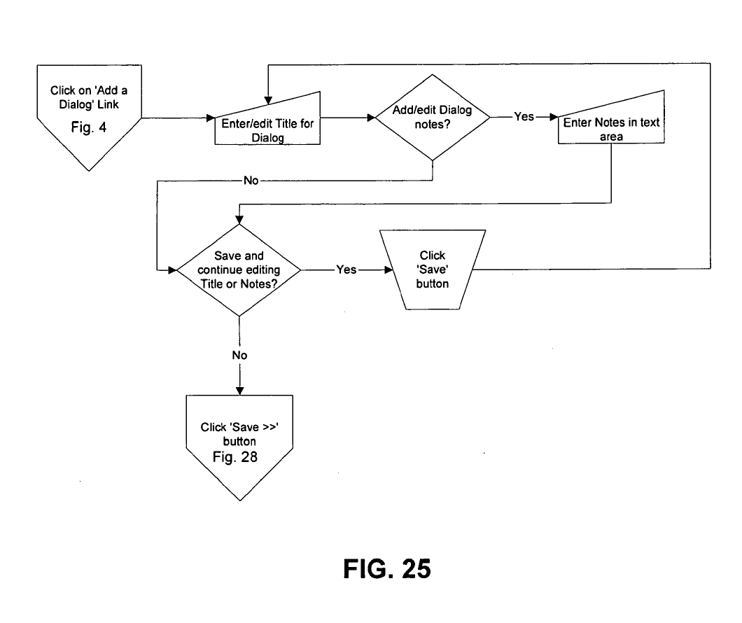

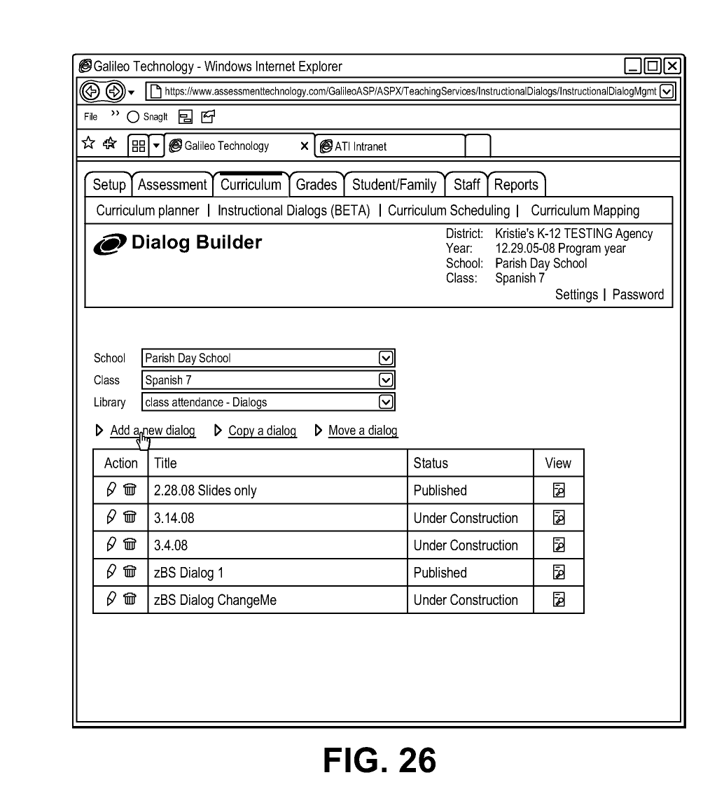

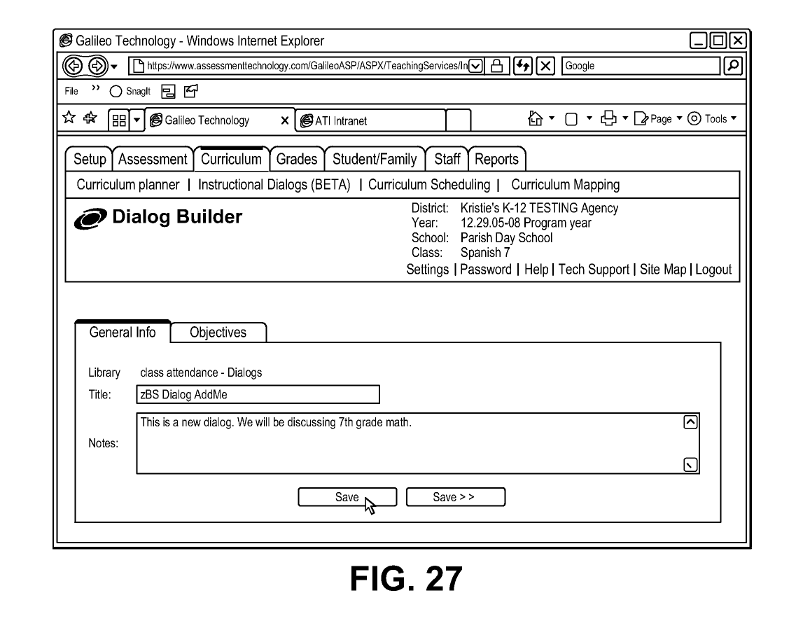

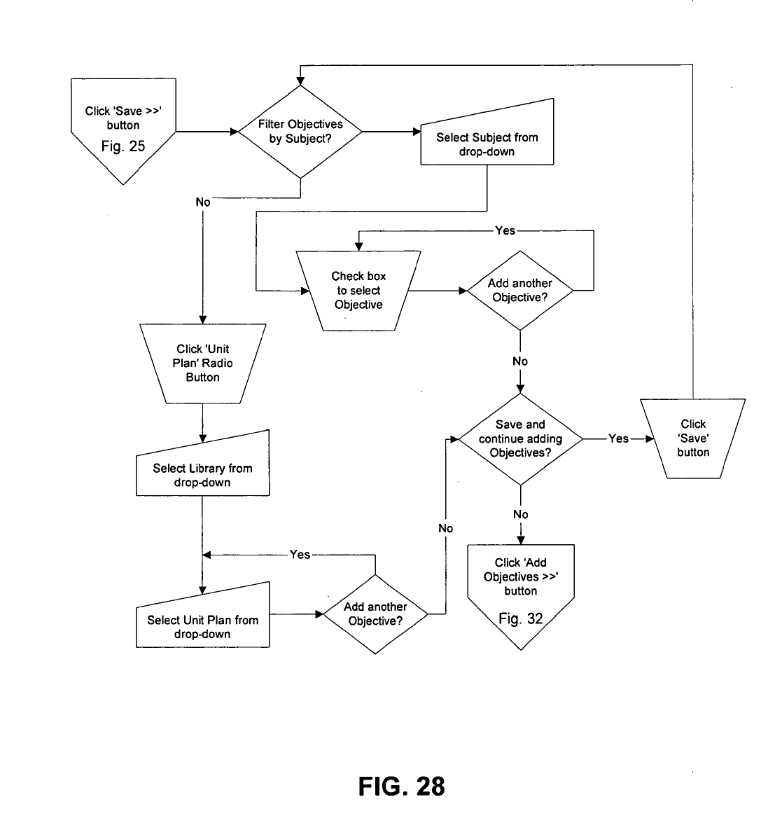

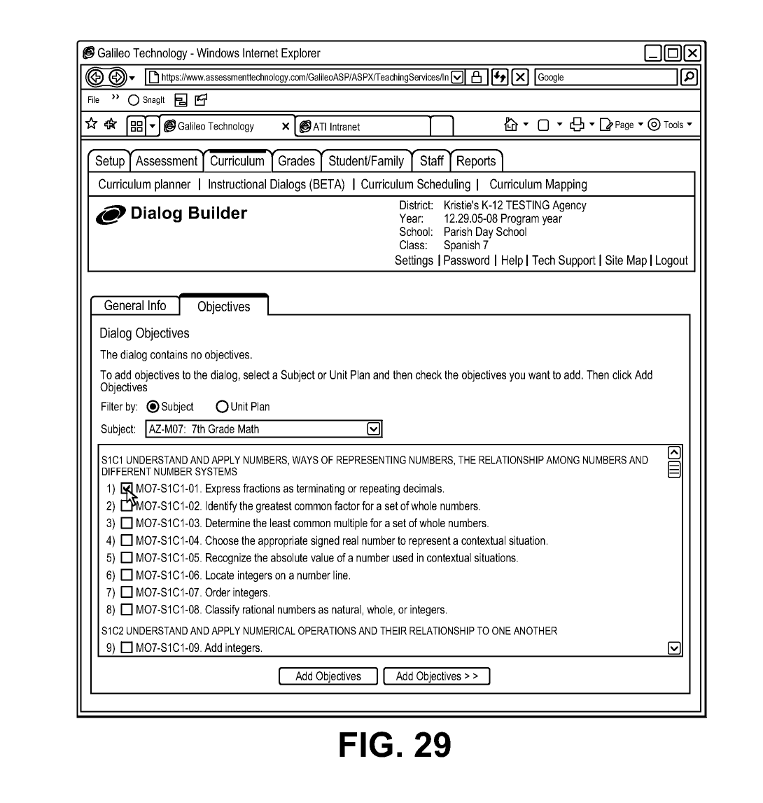

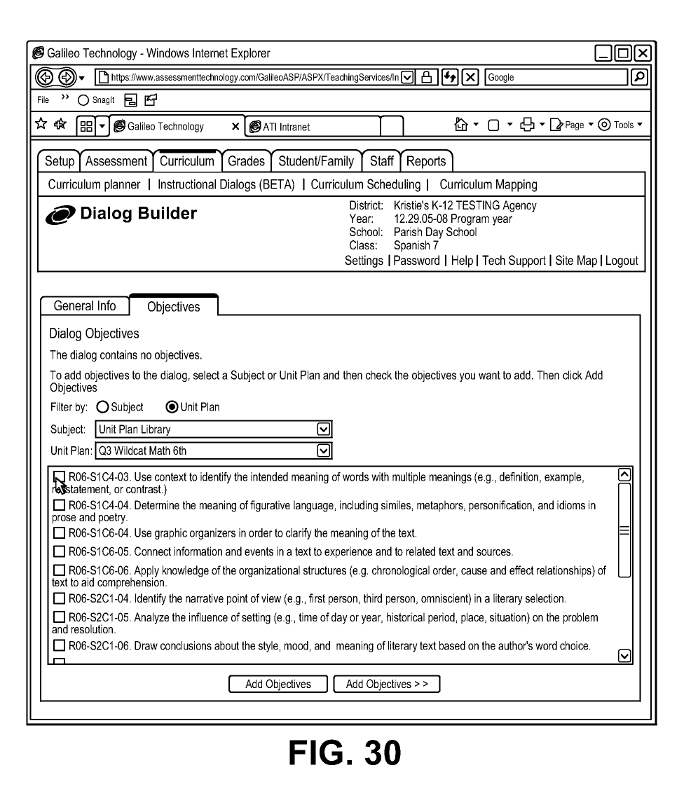

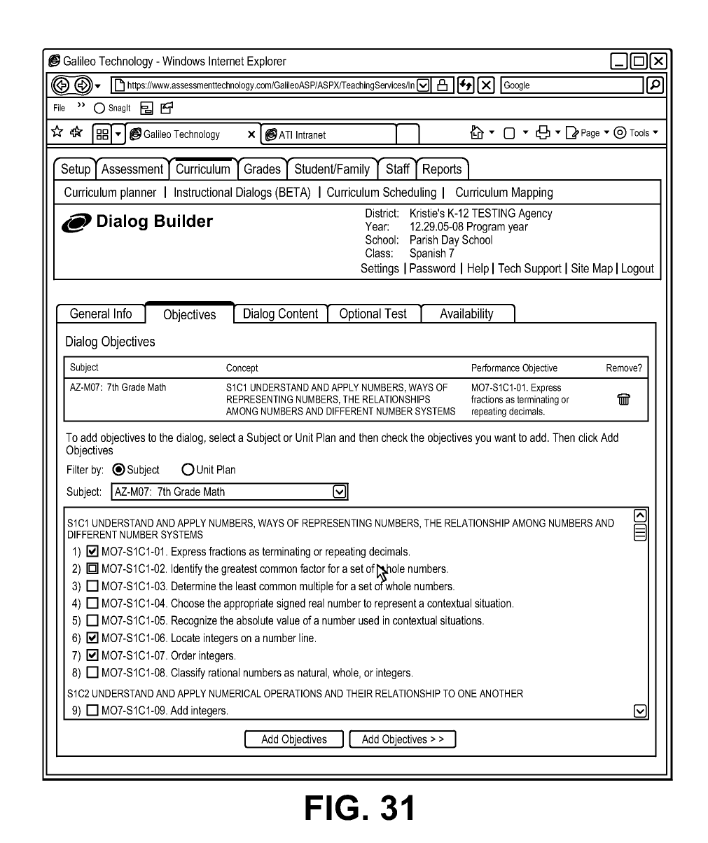

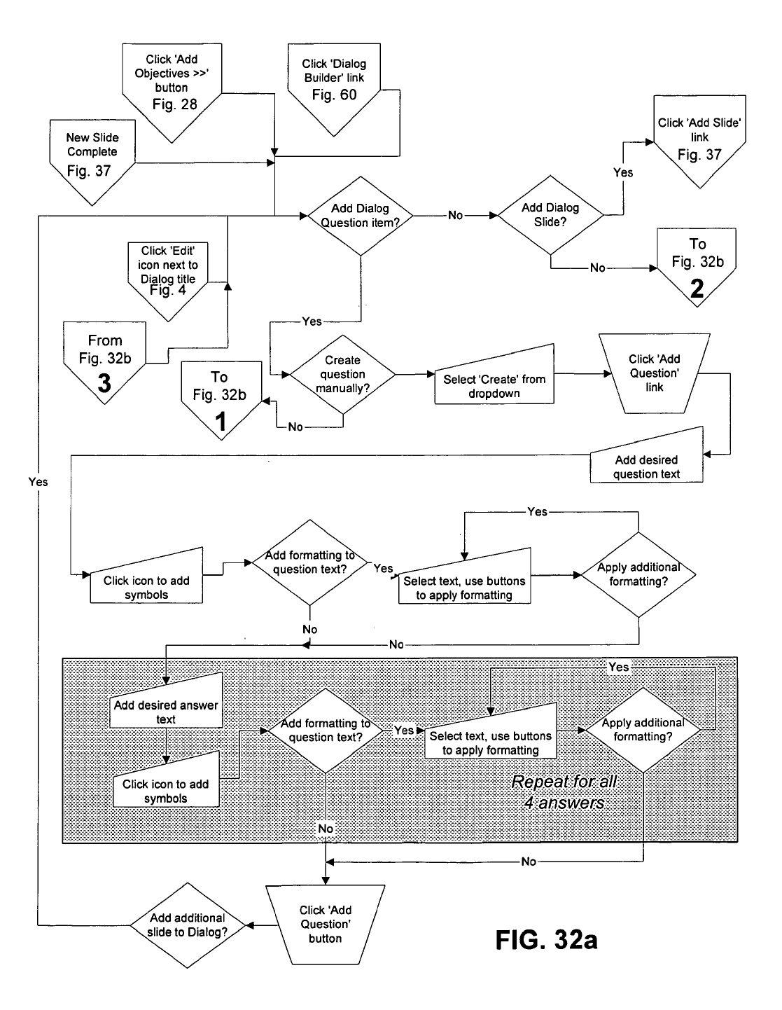

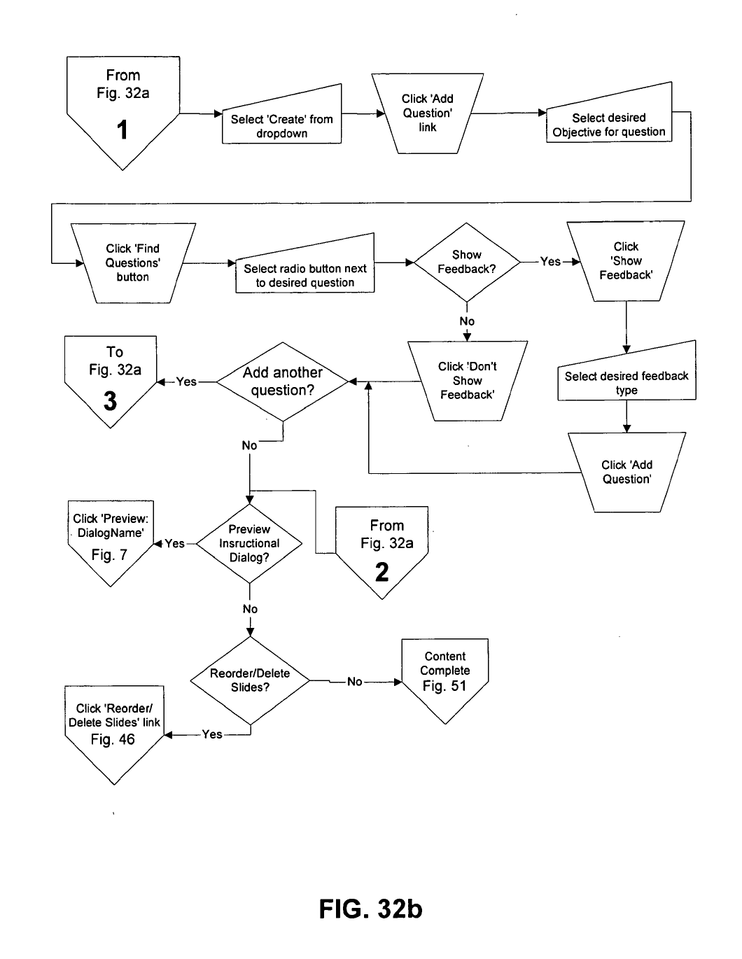

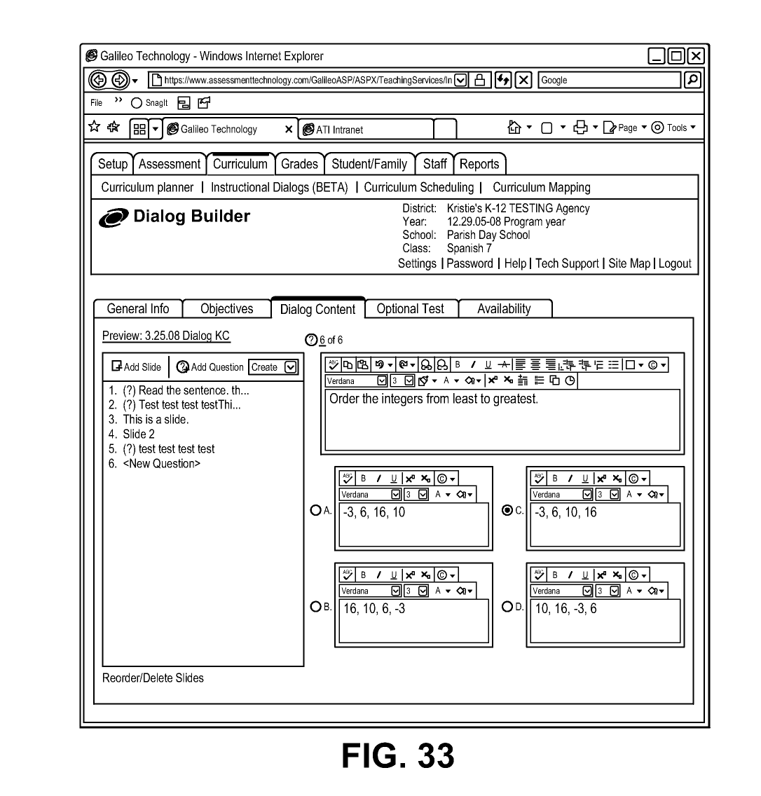

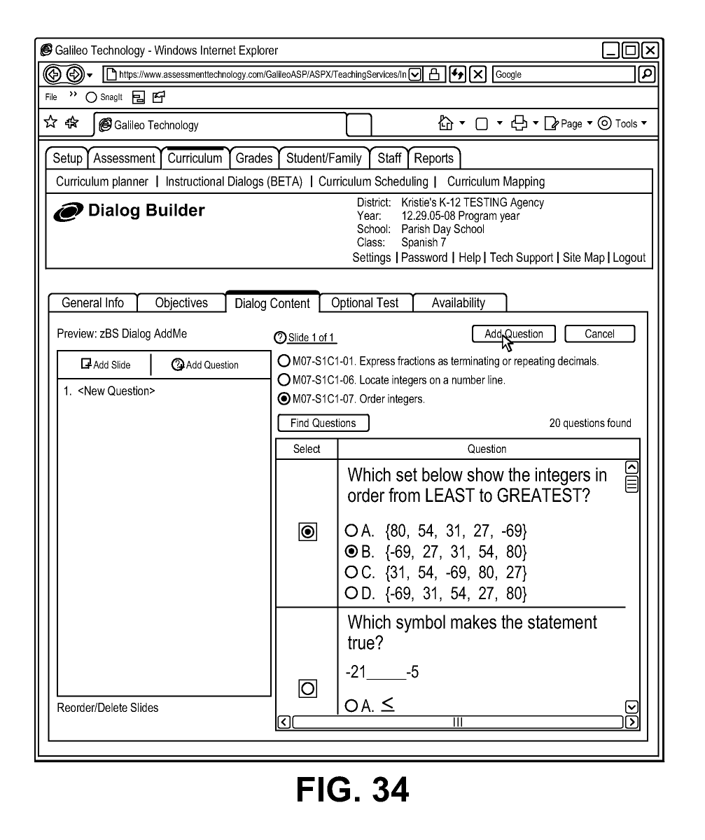

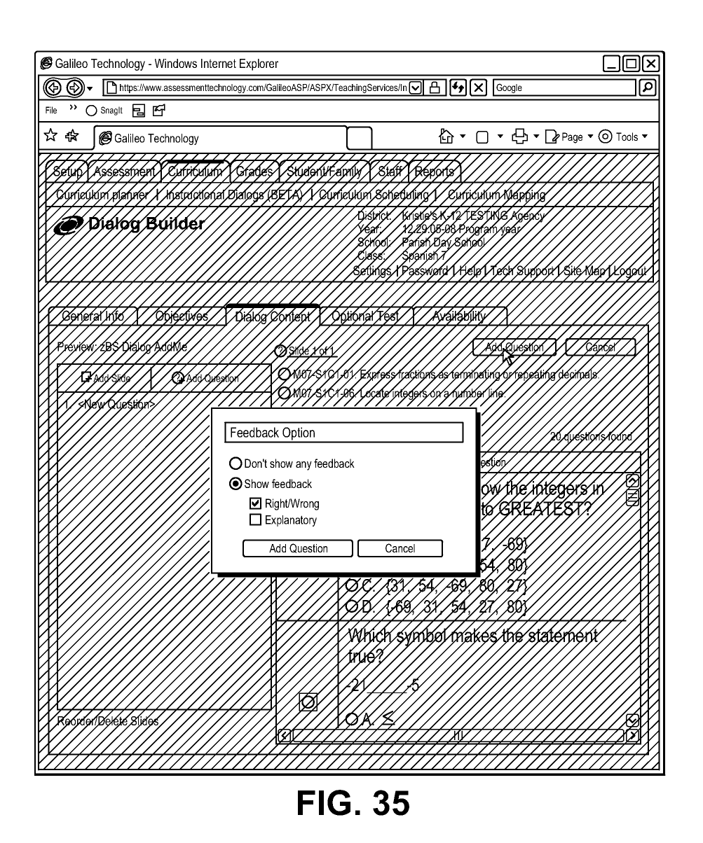

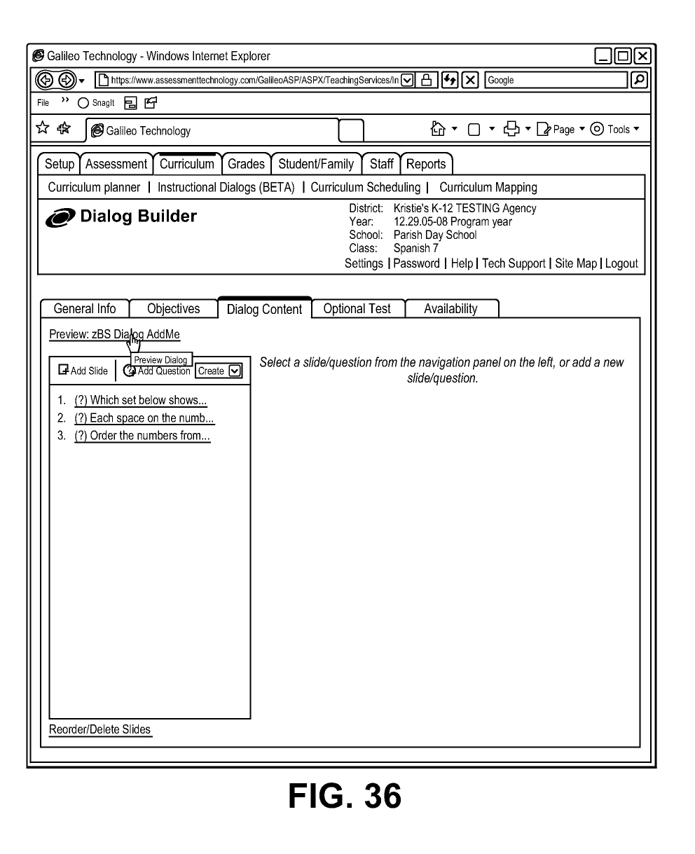

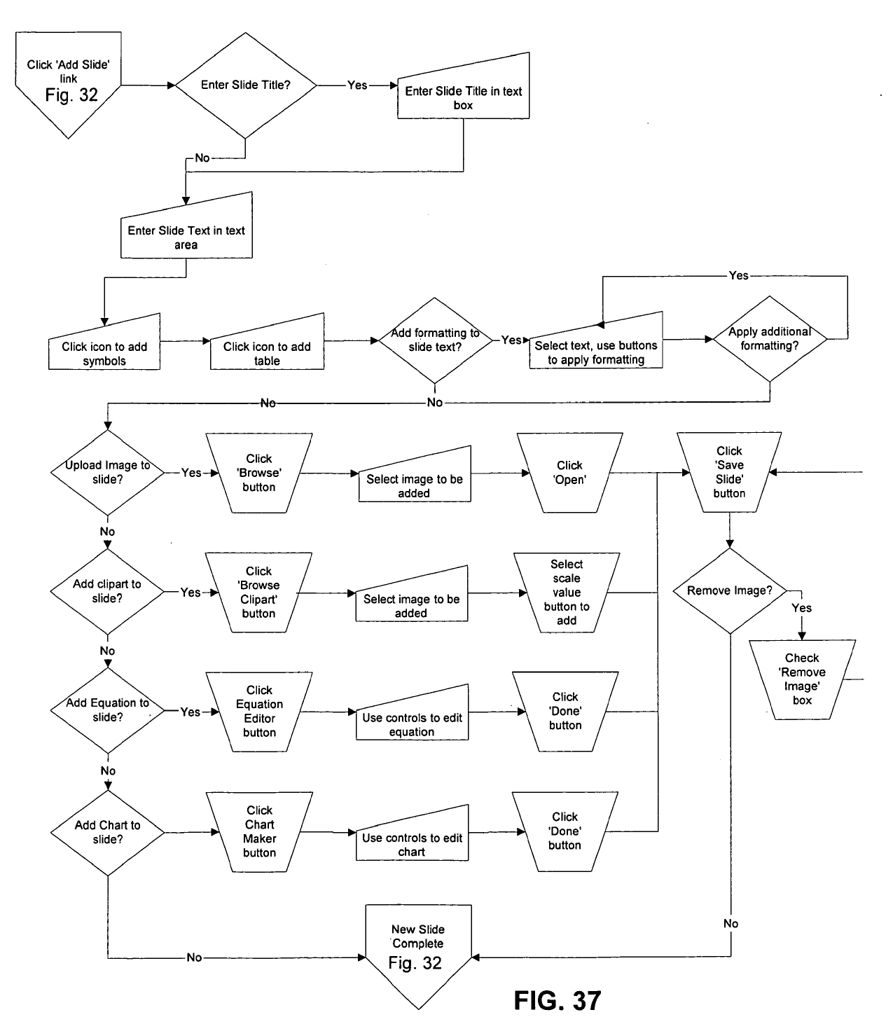

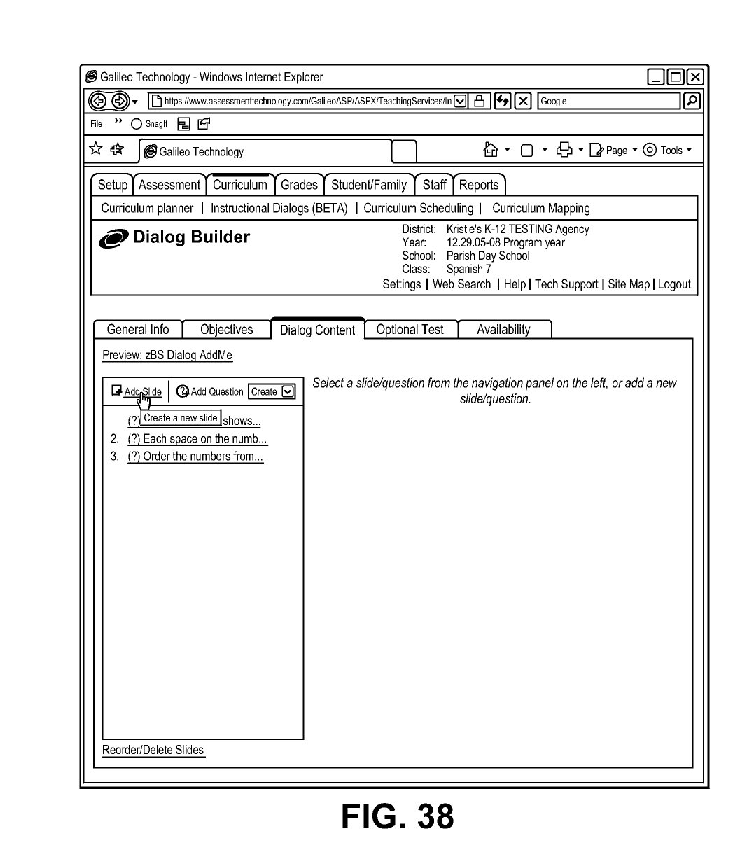

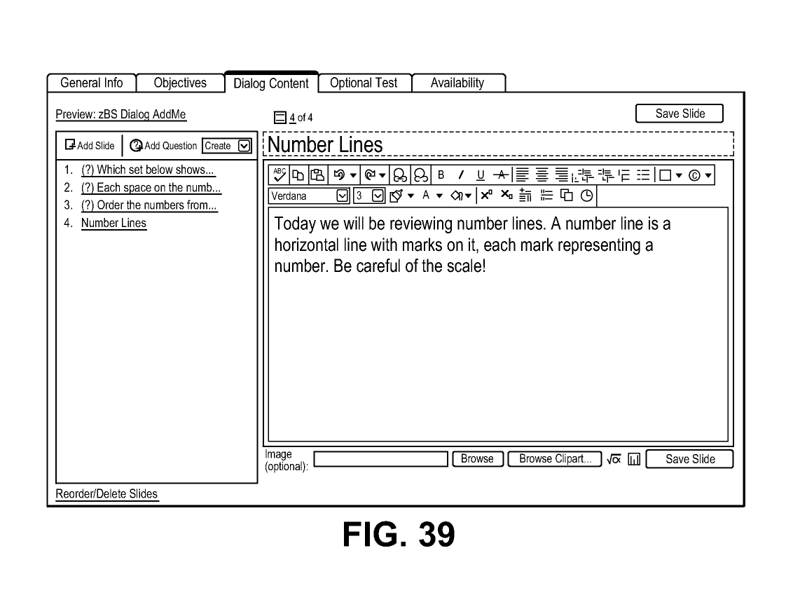

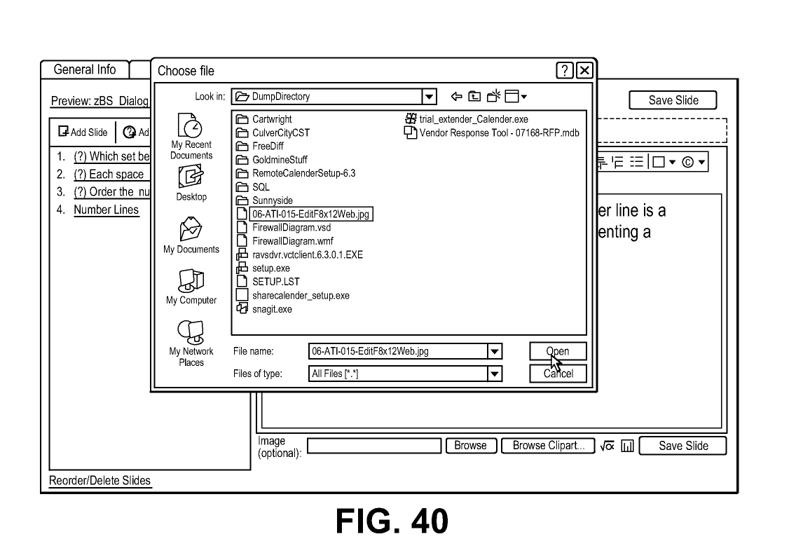

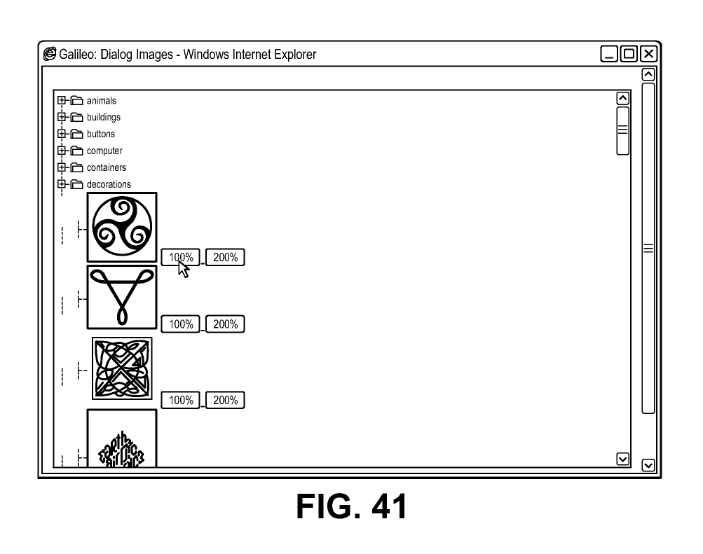

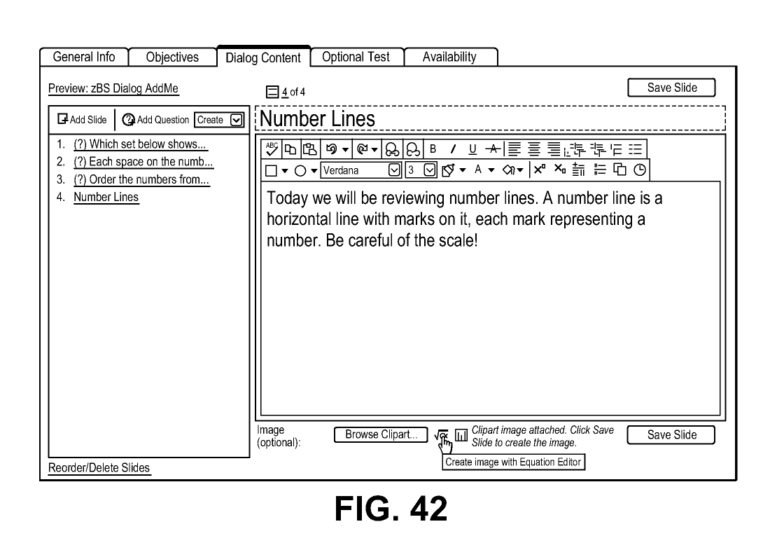

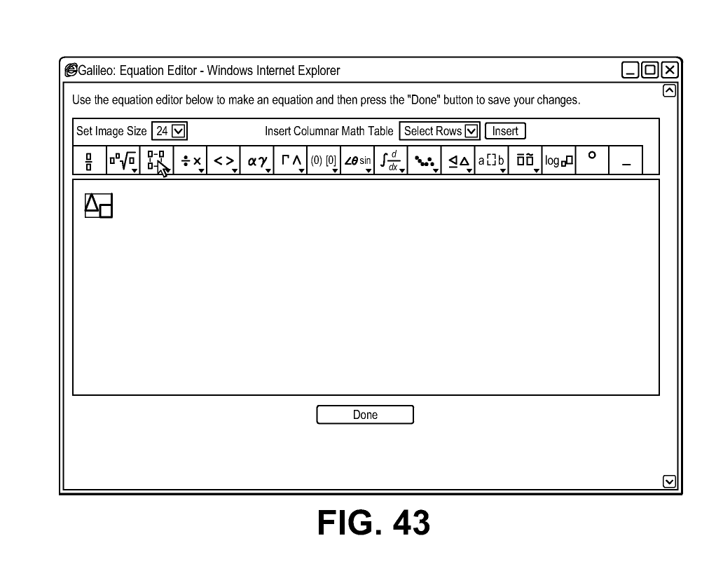

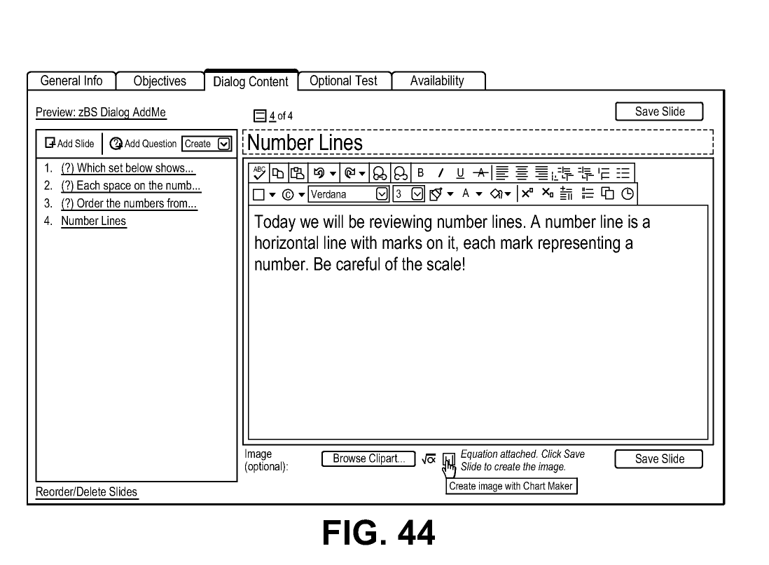

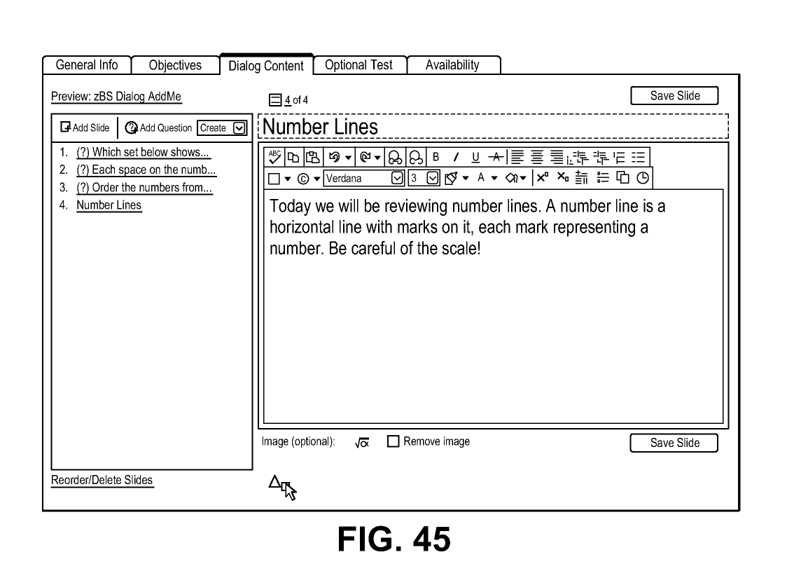

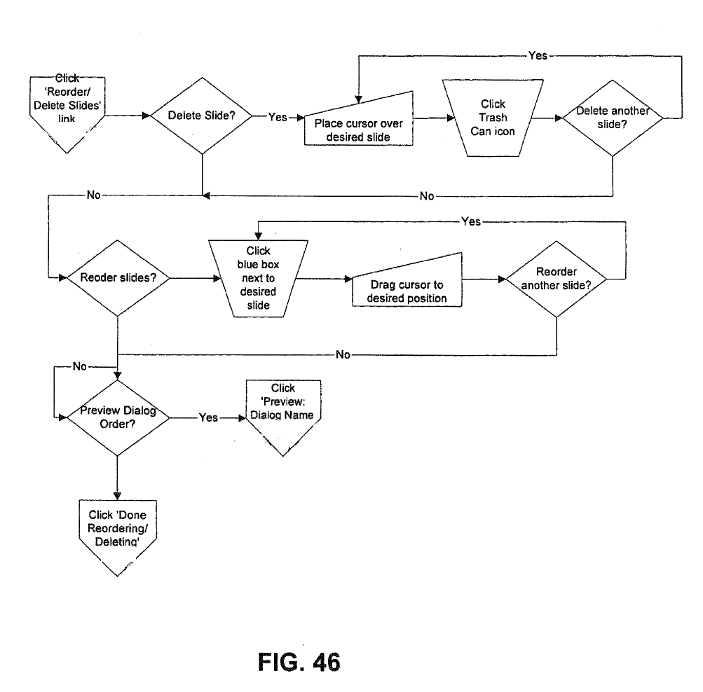

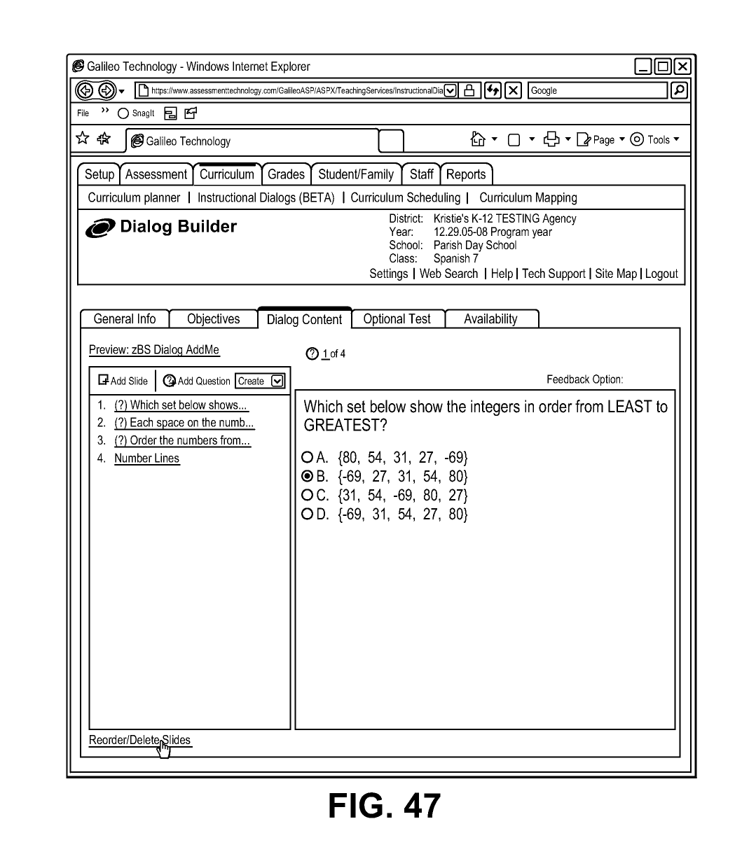

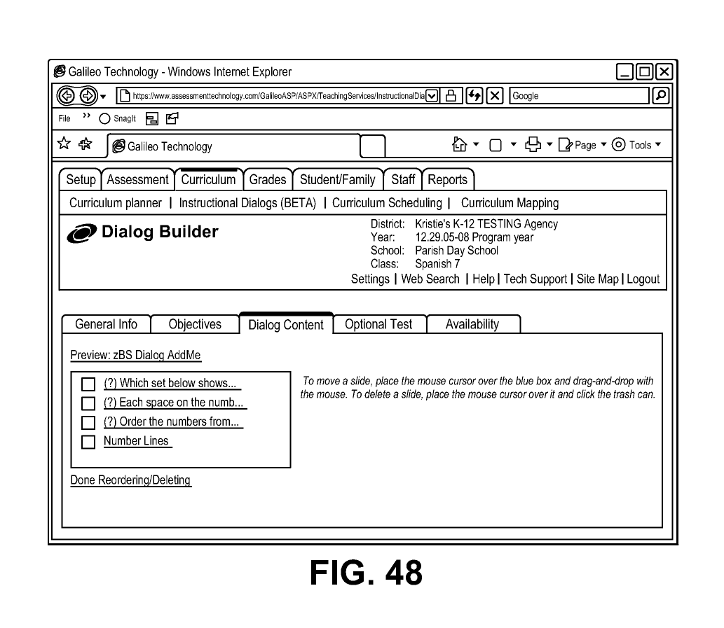

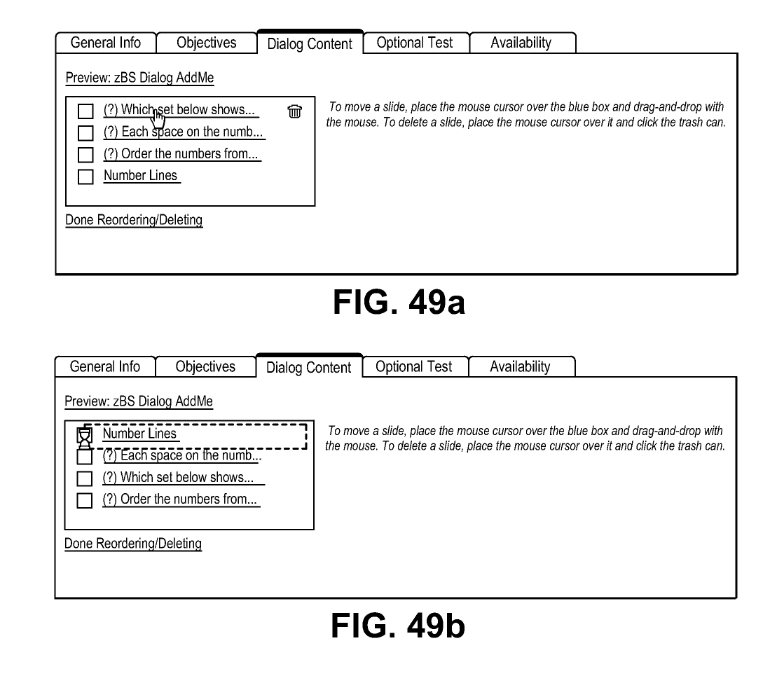

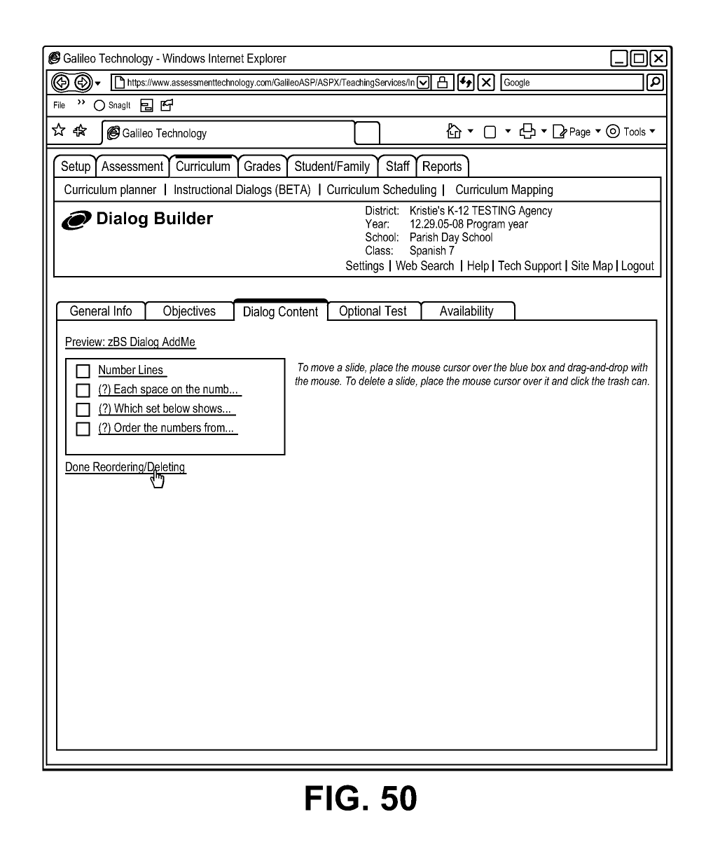

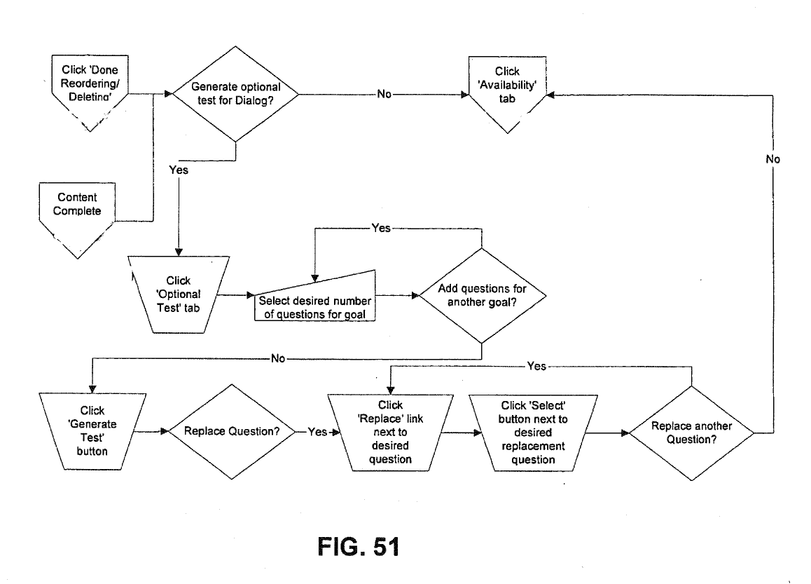

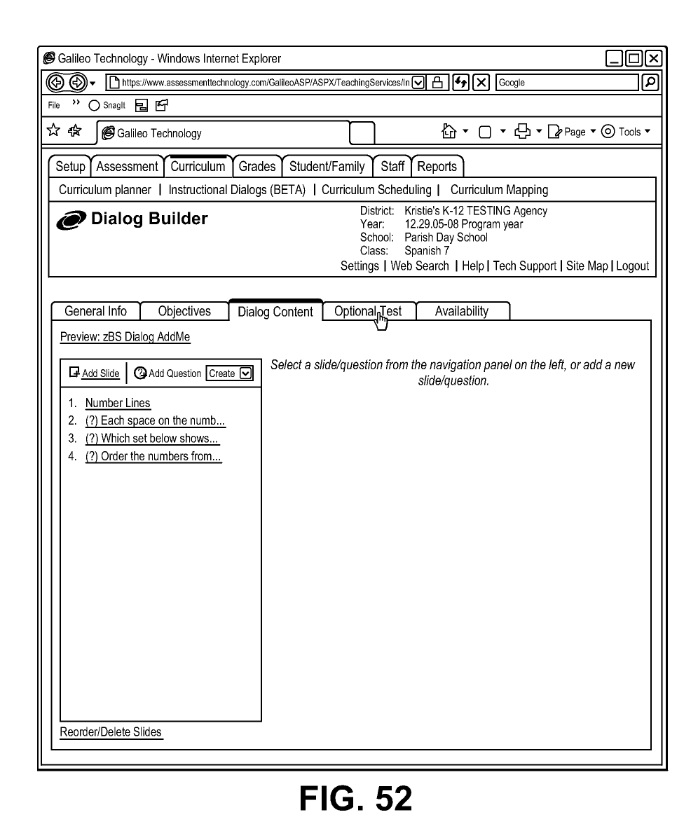

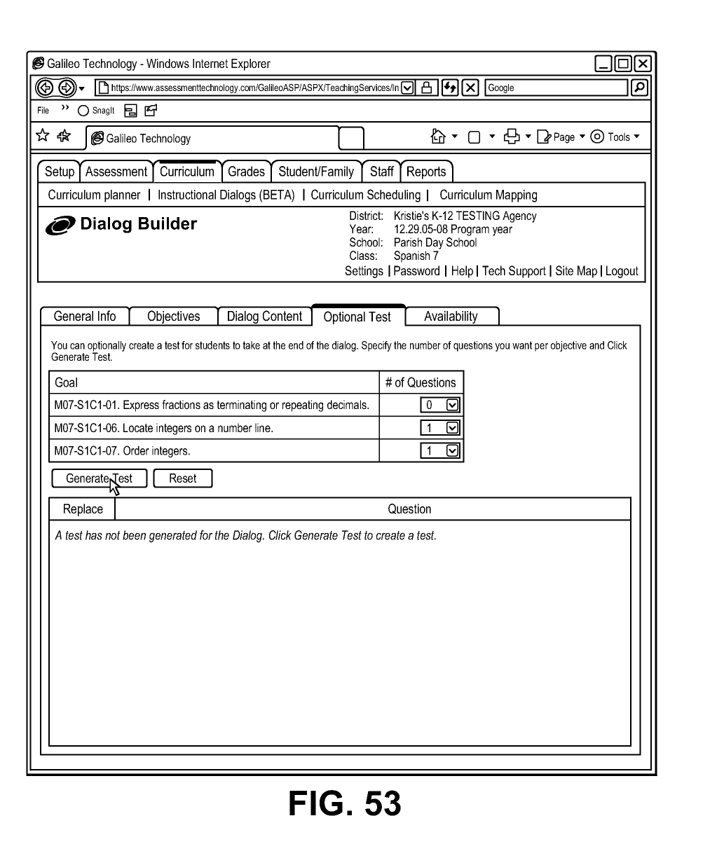

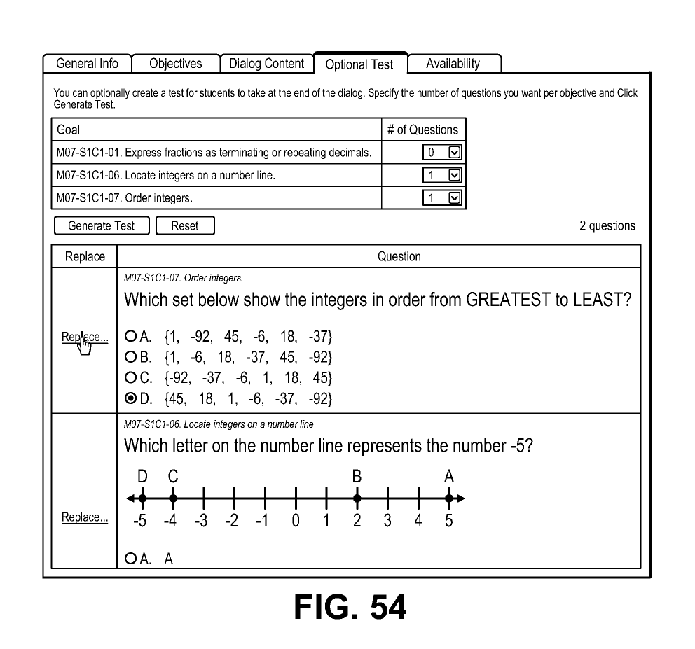

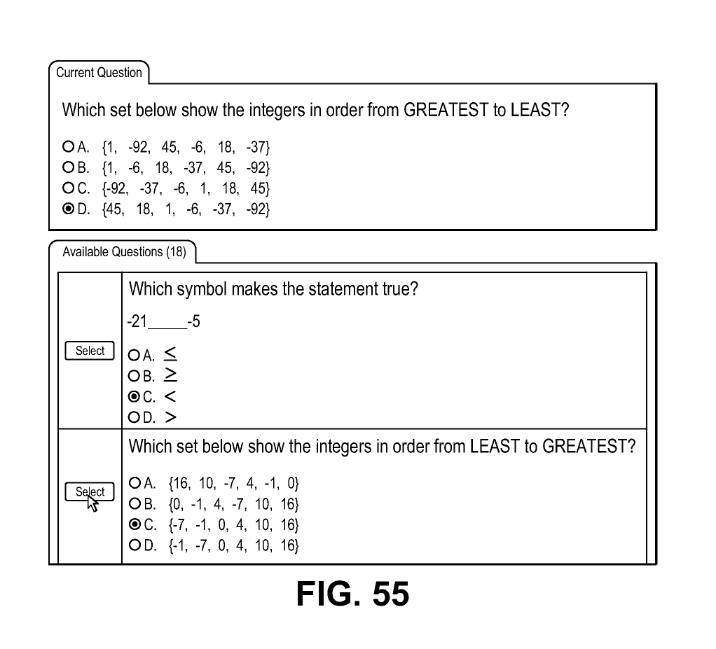

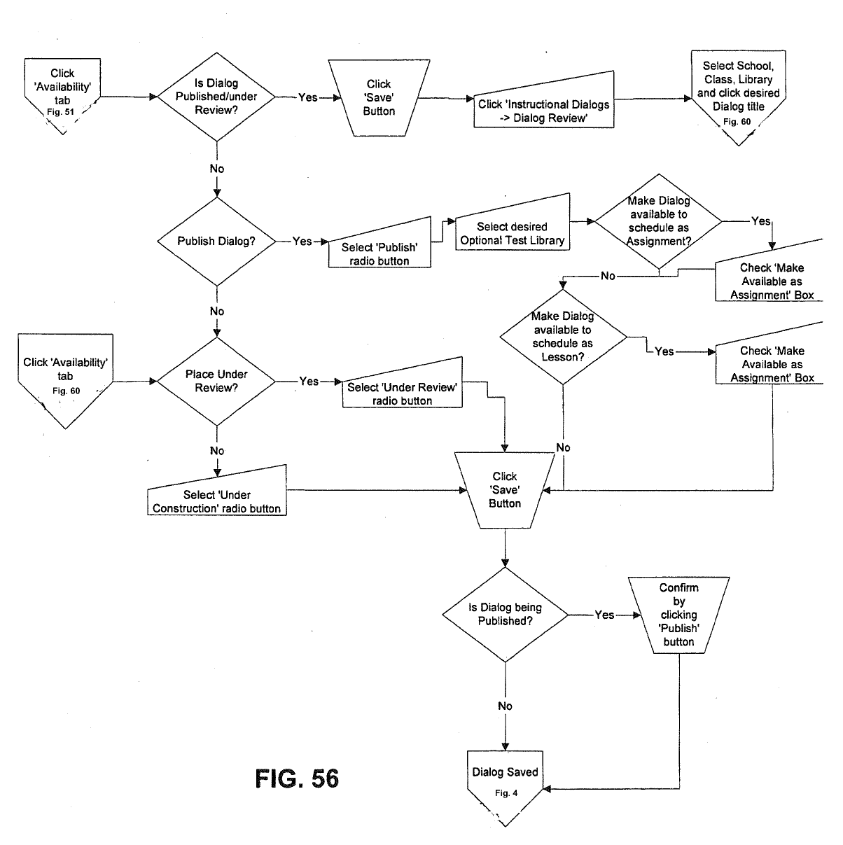

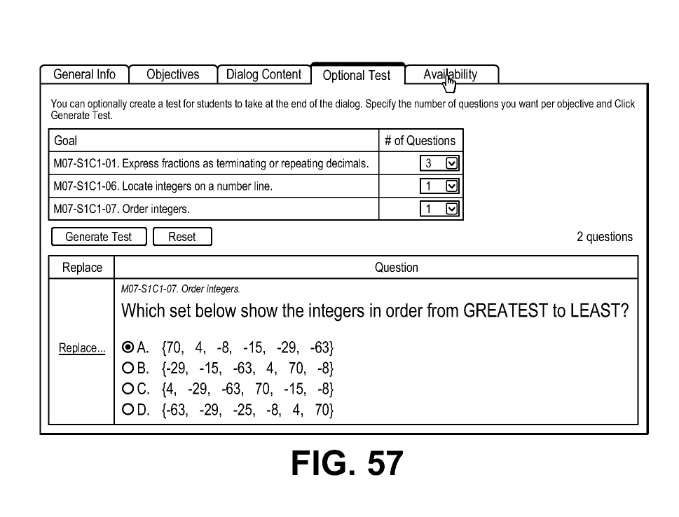

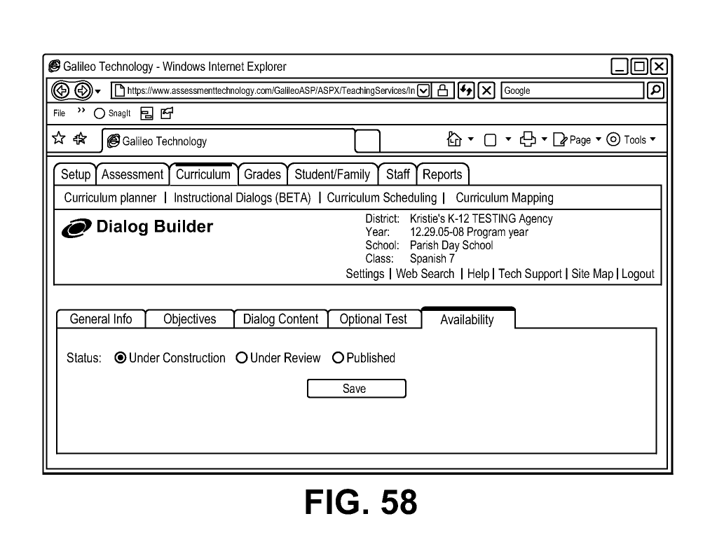

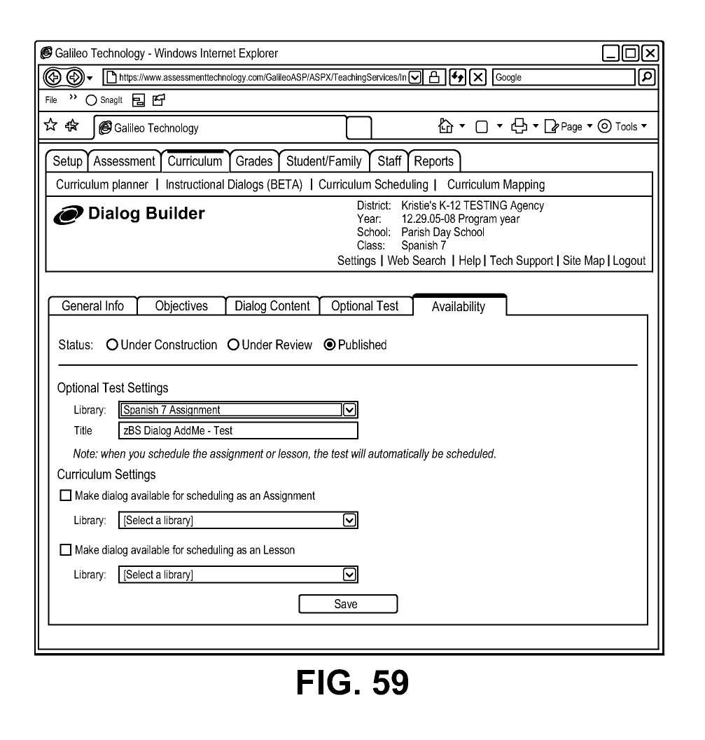

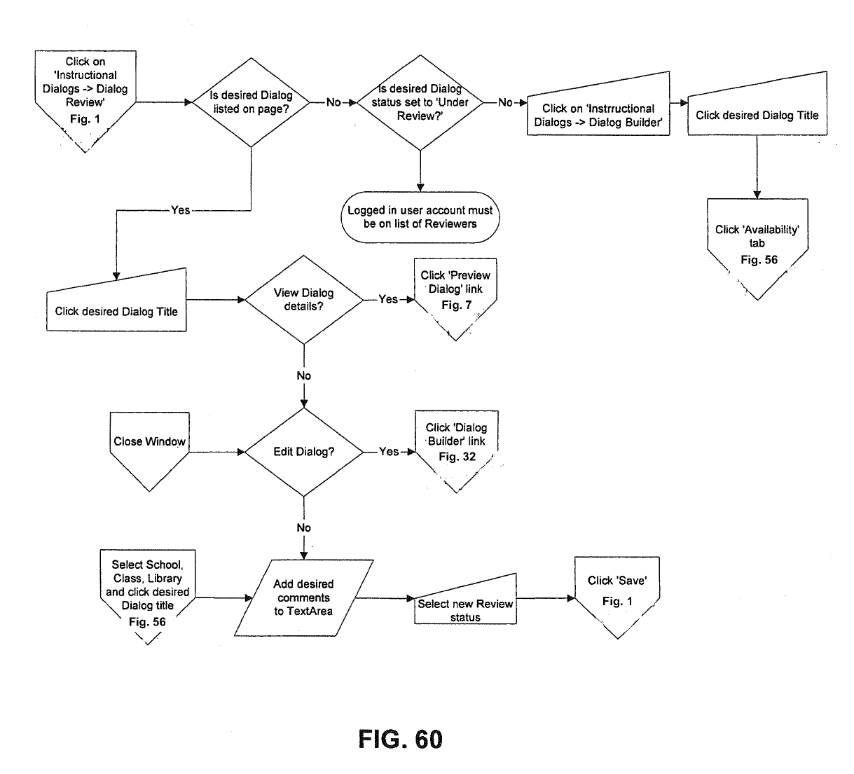

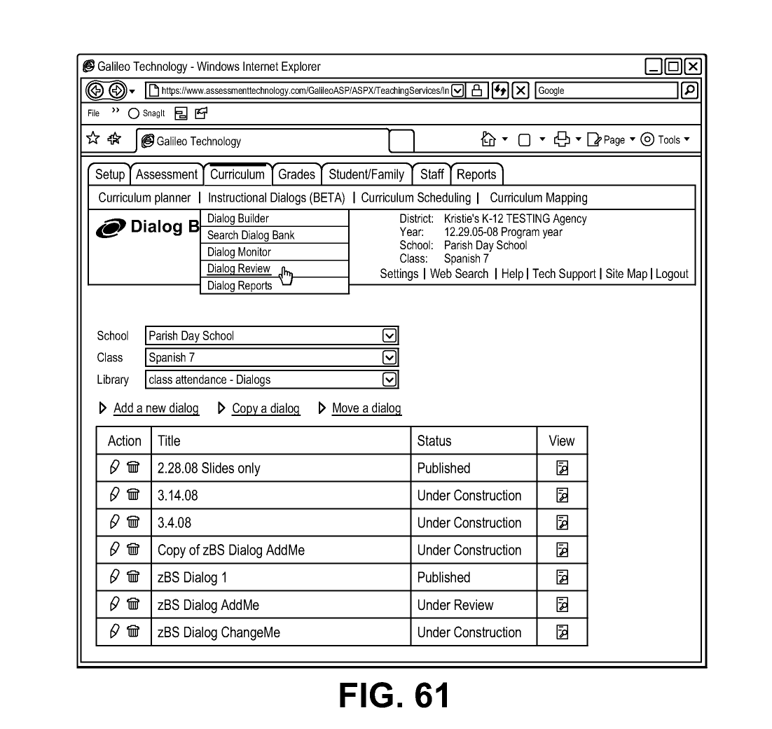

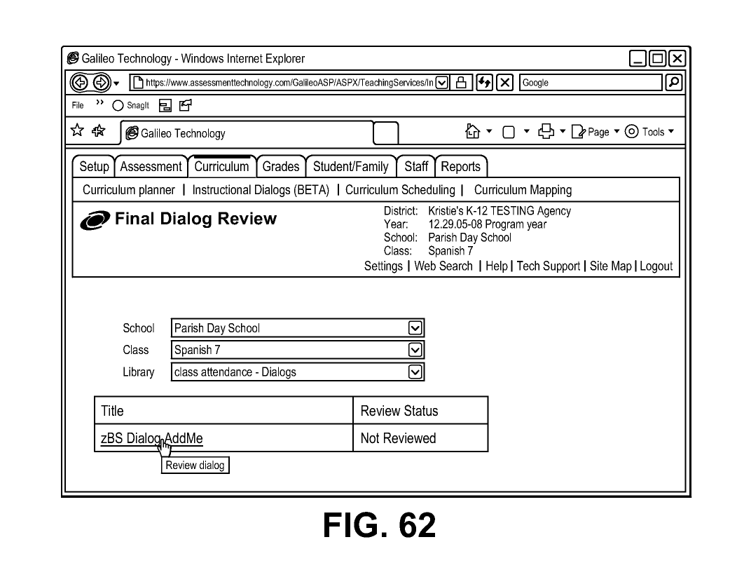

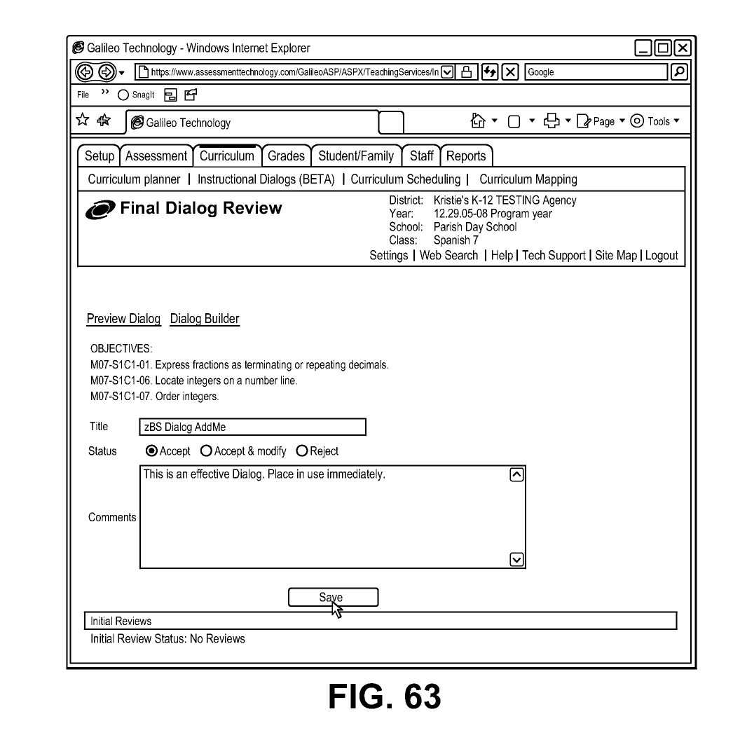

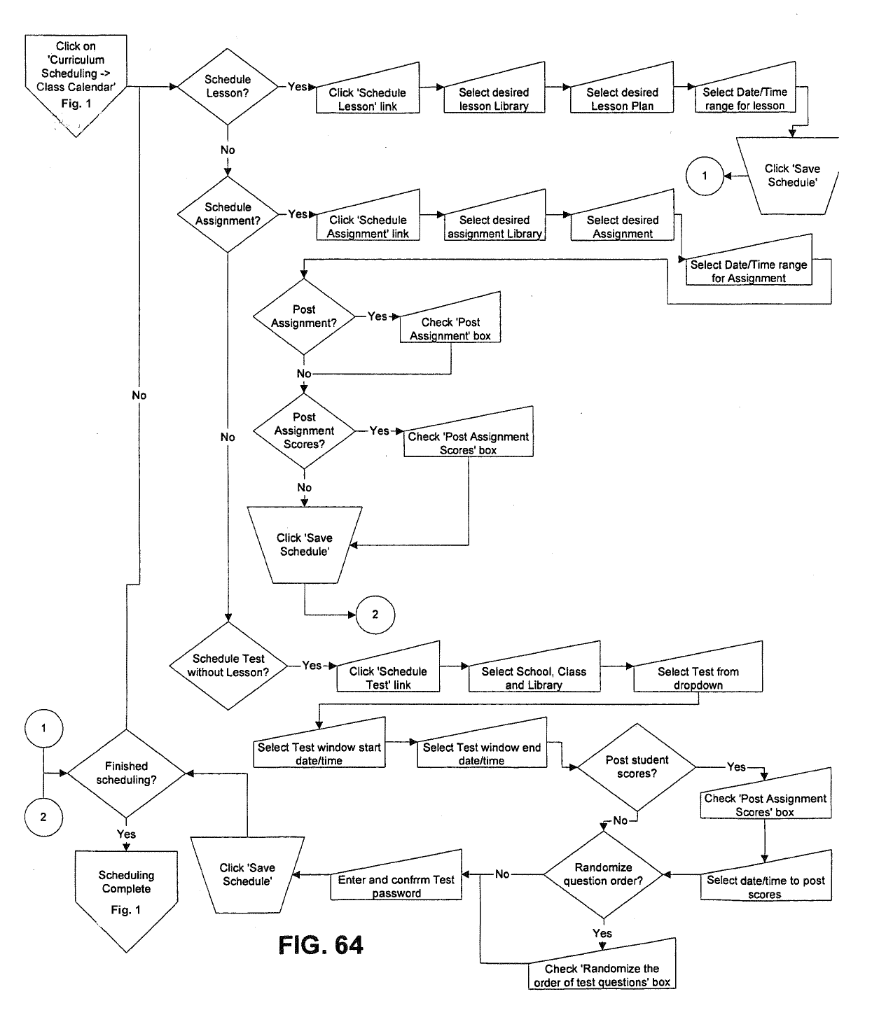

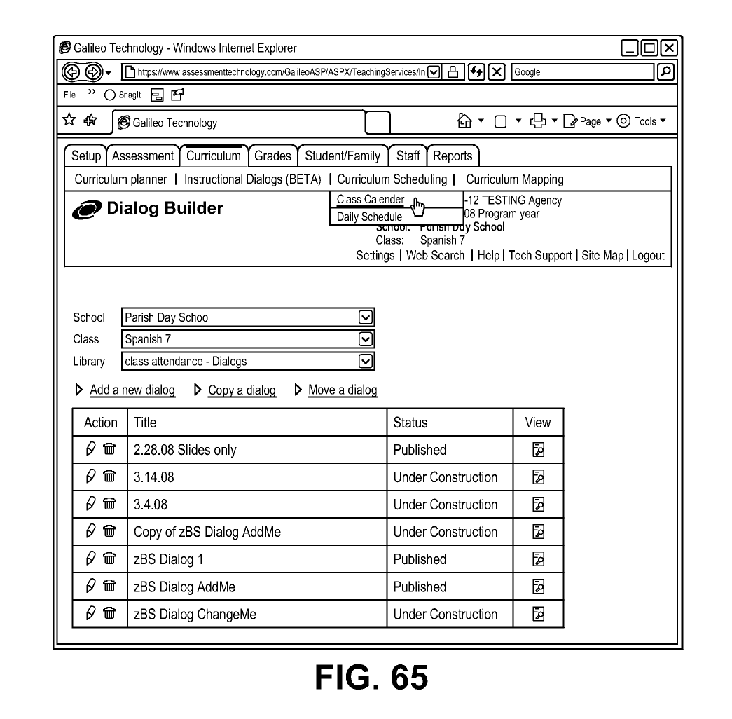

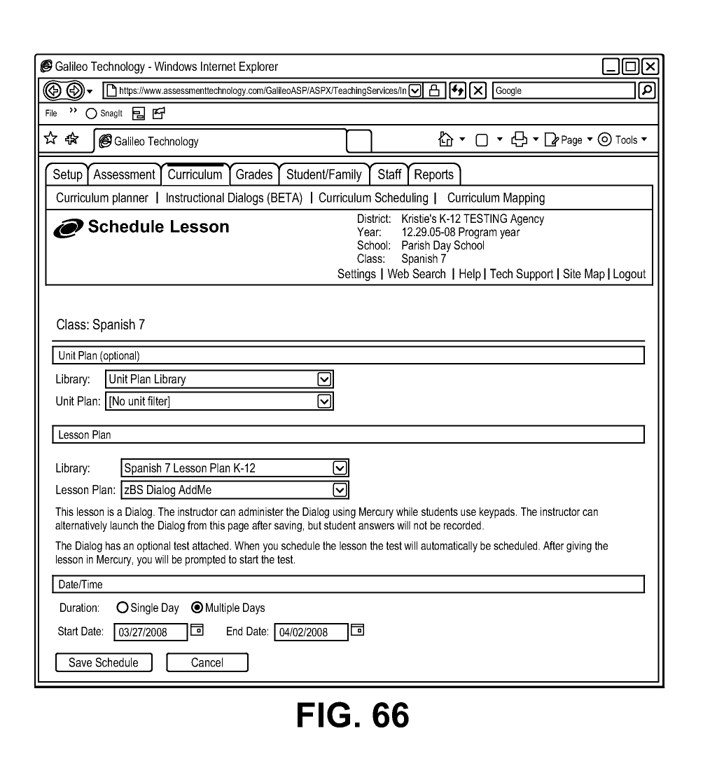

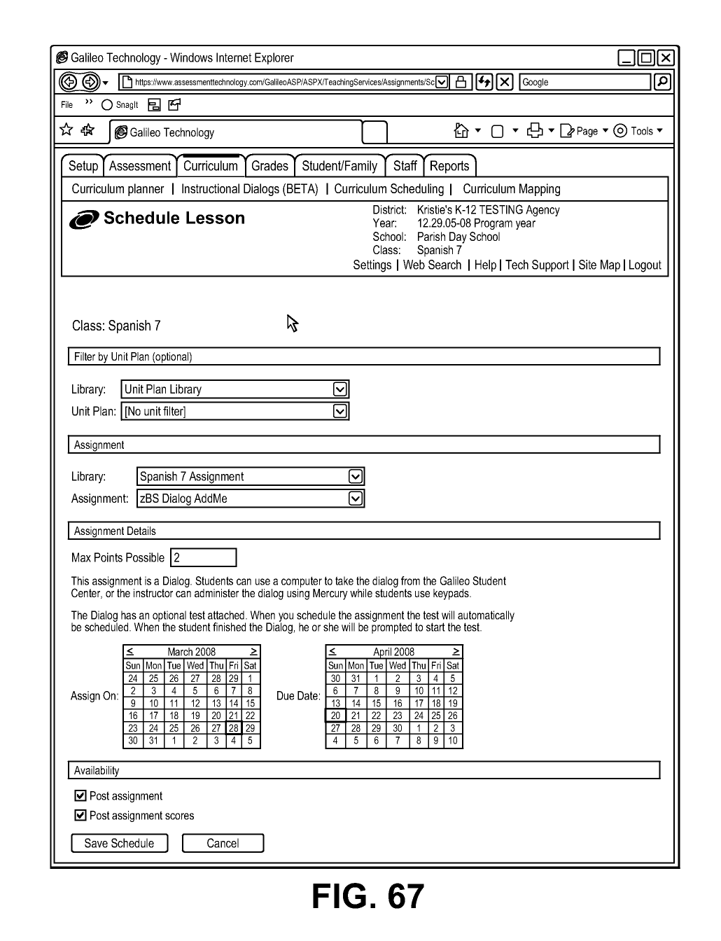

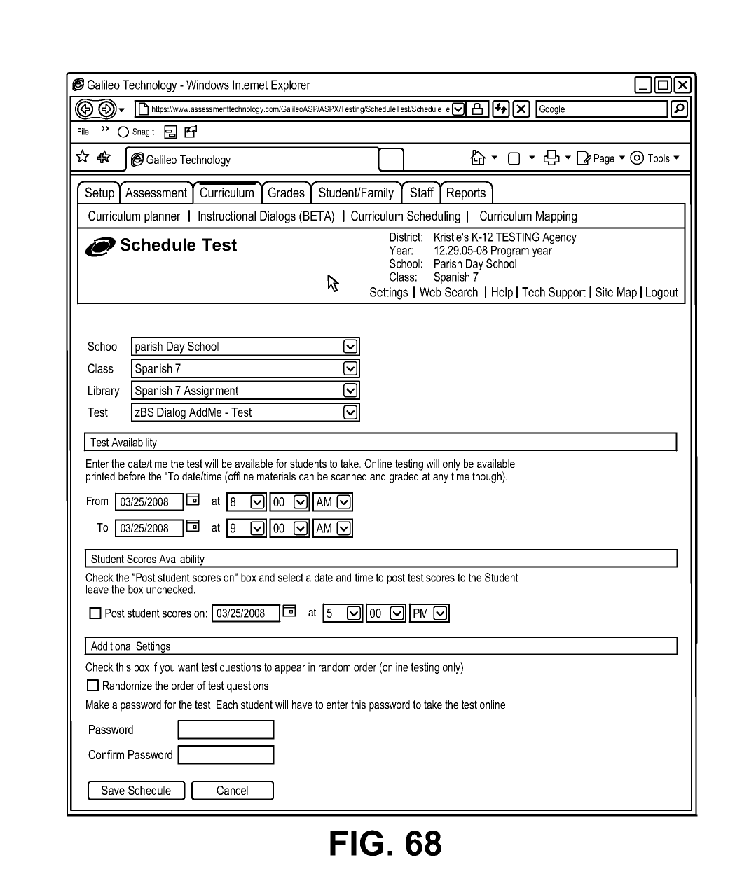

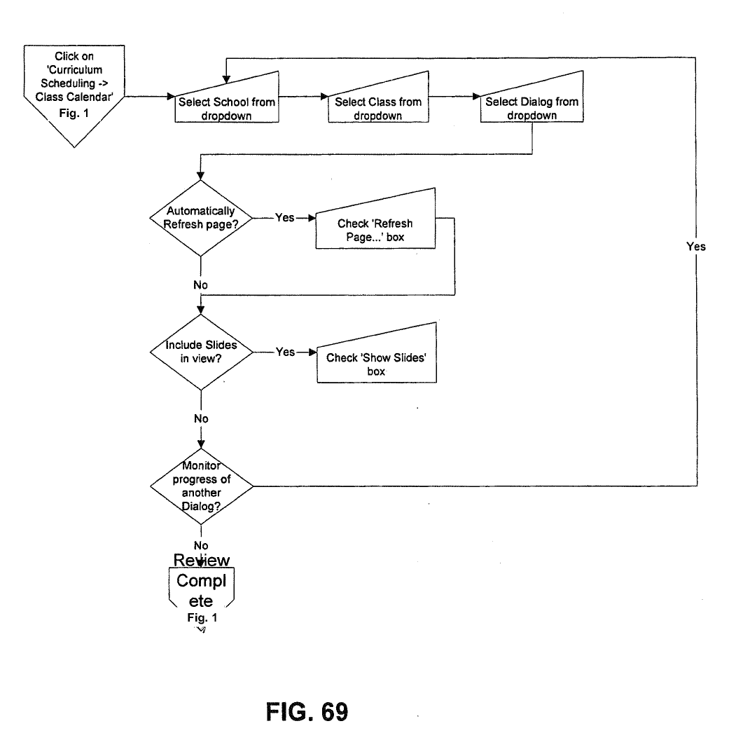

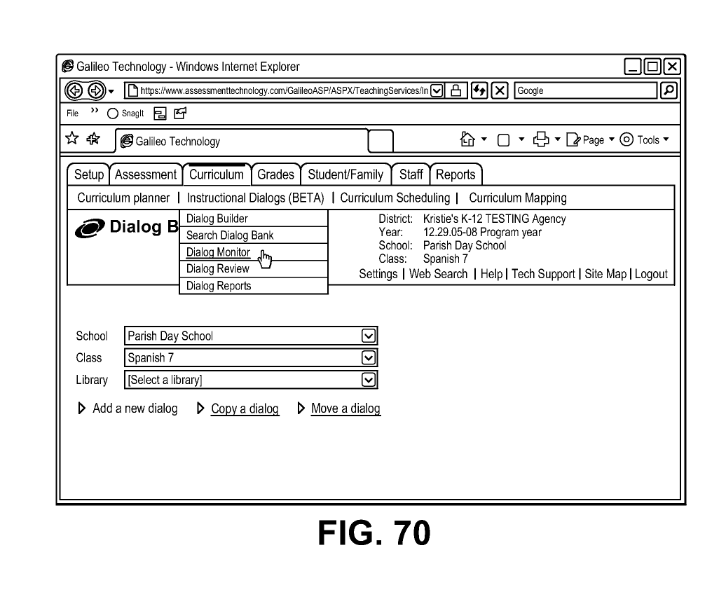

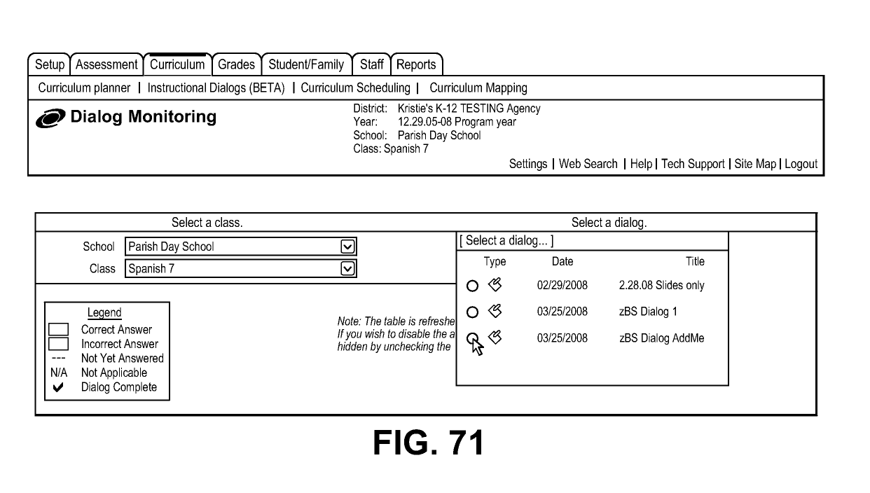

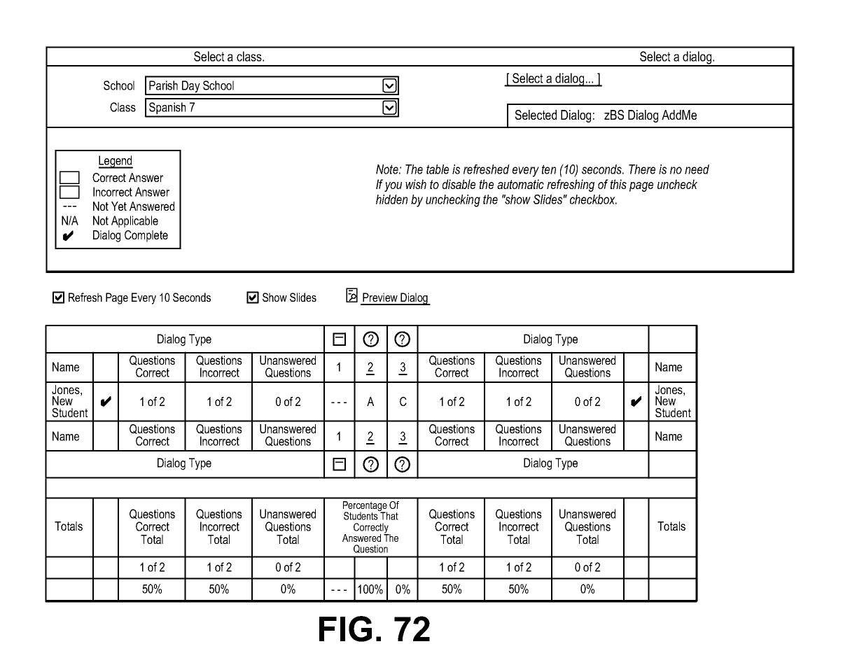

### DETAILED DESCRIPTION OF THE INVENTION

The discussion that follows outlines the characteristics of online instructional dialogs being introduced into the Educational Management system. The introduction of dialogs into the system provides a number of unique benefits. First, dialogs integrate online interactions between students and teachers into the curriculum. The present dialog technology makes it possible to implement dialogs in lesson plans, assignments, and benchmark and formative assessments used to inform instruction. A second benefit accrues from the fact that online instructional dialogs being introduced provide a permanent record of instruction indicating what has been taught and what has been learned. The record of instruction provides actionable information that can inform future instruction. In addition, the record can be used to document the implementation of instructional interventions. One of the major problems in educational research designed to evaluate the effectiveness of an intervention is that of determining the extent to which the intervention was actually implemented. Dialog records can be useful in addressing this problem. A third benefit to the dialog technology being introduced is that it can be used to rapidly produce and share large numbers of instructional activities that can be implemented by a teacher in class or carried out independently by students completing online assignments. Dialogs constructed by teachers can be vetted using an online Dialog Review feature. After a dialog is vetted, it can be assigned to a library that is shared by members of a larger learning community. For example, dialogs could be shared by a group of school districts who have agreed to share instructional resources.

### Defining Characteristics of Dialogs

An online instructional dialog may be defined as a series of online communications among students and their teacher. Communications may include the presentation of a lesson, discussion of the lesson, and assessments of the mastery of lesson objectives. The instructional dialog feature in K-12 online instruction supports the construction and implementation of instructional dialogs between teachers and their students aimed at promoting the mastery of educational standards. The present dialog technology makes it possible for teachers to ask questions aligned to state standards and to monitor student responses to those questions electronically. Dialog technology also supports student communications and provides teachers with the capability to respond to student questions electronically. Teacher questions can be in the form of tests composed of items aligned to standards. Teacher questions may also take the form of informal notes posed in real-time or test questions entered into the system in real-time during a student-teacher dialog. Student-initiated communications take the form of informal notes, which may cover a range of topics. For example, a student may ask for help with a problem or express a perspective on the problem.

### Equipment and Networking Configurations

Implementation of an online instructional dialog in the present system requires one or more client computers and/or hand-held devices connected to a network. In addition, the network has to provide access to servers housing the present application. In some cases, a projector may be attached to one or more of the computers in order to display dialog content on a screen or a white board. For example, a dialog could be implemented by a teacher with a computer with Internet access and students with hand-held response pads capable of sending and receiving information wirelessly to the teacher's computer. The teacher's computer would access servers hosting the present application over the Internet. This would make it possible to make student and teacher communications available through the present application. A projector could also be attached to the teacher's computer to display dialog content such as test items or lessons accessed from present application.

In the above example, the teacher's computer plays a direct role in the transmission of information to and from present application. However, this is not always necessary. Dialogs may be implemented in cases in which the teacher and each student have a computer with Internet access. Under these conditions, dialog content available through present application could be displayed directly on each student's computer. Moreover, student responses transmitted to present application could be displayed directly on the student's computer and the teacher's computer.

In some cases students may not have access to online devices such as response pads or computers. In those instances in which responses initially occur offline, student responses may be scanned in and recorded using scanning equipment and commercial software. For example, this would be the case if the students took a classroom test offline. In this situation, the record of the dialog would be maintained online so that further online or offline communications could occur regarding student responses.

### Scheduling Dialogs as Assignments and Lessons

In order for a dialog to be initiated, it must be scheduled. Dialogs are scheduled by entering the name of the dialog and specifying a start date and an end date defining the time period during which the dialog is intended to be available. When a dialog is scheduled, two-way communication becomes available. The dialog may be selected from a dropdown control and initiated by the user (teacher). A dialog is completed when no further two-way communication is scheduled. A dialog may be suspended prior to completion. Suspension occurs when, prior to completion, dialog participants are no longer communicating online. When a dialog is either suspended or completed, the record of student-teacher interactions persists. A completed dialog may be resumed at any time by rescheduling it.

### Real-time and Asynchronous Communication

Dialog scheduling provides a basis for supporting real-time and asynchronous communication between teachers and students. Scheduling makes it possible to maintain continuous dialogs over extended time spans involving multiple locations. Real-time communications are possible only when teachers and students are online at the same time. However, they need not be in the same location. For example, real-time communication may take place when students and their teacher are online during a class period. However, the class could be held in multiple locations. Asynchronous communications can occur at any time from any connected location.

### Constructing and Editing a Dialog Presentation

Dialogs are provided to users in libraries. Users may select dialogs and implement them. A significant innovative feature is that dialogs can be constructed by users. Moreover, users may copy and edit existing dialogs. Users construct and/or edit dialog presentations in Dialog Builder. Dialog builder allows the user to create multiple slides (pages) including text entered through a text editor and equations entered through an equation editor. The user is also able to include images, charts, and audio-visual presentations including interactive presentations in each slide. Dialog builder also allows the user to build practice materials as part of a dialog. Practice materials are comprised of sets of assessment items that provide feedback regarding student performance.

A particularly innovative feature of dialog builder is that it makes it possible for the user to include in an instructional dialog sets of items selected from the thousands of assessment items in formative item banks. Moreover, the feature insures that the items will be aligned not only to standards, but also to detailed item specifications making it possible to assess component skills that may be included in standards. Finally, the feature enables the user to add various forms of feedback to the items, which enhances their value for instruction.

To include items in a dialog, the user selects the standard(s) to be addressed from a dropdown control. The user also enters filtering information affecting the automated selection of items aligned to the standard(s). Then the user presses a generate-quiz control. The system then generates a quiz corresponding to user specifications. To include feedback for each item in the quiz, the user checks the feedback option. Two types of feedback are provided. Automated feedback indicating whether the item has been responded to correctly or not is given. In addition, explanatory feedback may be given. Explanatory feedback offers explanations as to the reason for incorrect responses and directs the student to instructional material designed to assist the student to arrive at the right answer. Explanatory information may be entered into the system for each item using the feedback interface. Automated feedback includes randomly selected sets of images and text designed to increase student interest as well as to indicate whether or not the student responded to the item correctly.

### Attaching Dialog Resources

Teachers may attach a broad range of instructional resources to a dialog. Teachers can attach readings, practice materials, pod casts, flash interactive presentations and other video presentations to a recorded dialog by attaching files to the dialog. Teachers can also attach resources housed in the application database or on the interne. To attach a resource, the teacher simply searches a resource library from the recorded dialog and selects the desired resource from the search results. Prior to final selection, the teacher may preview the resource. When the final selection is made, the attached resource may then be displayed to the students at any time during the dialog presentation.

### Attaching a Test to a Dialog

Teachers may attach a test to an ongoing dialog by selecting the test from a drop down menu. The selection brings up the test scheduler and associated calendar. The newly attached test becomes available in the dialog at the time that it is administered. In the event that a dialog contains more than one test, the most recent test is displayed as the default. However, earlier assessments may be selected from a list of all assessments included in the dialog.

### Scheduling Dialogs as Assignments

Teachers may schedule a dialog as an assignment. To schedule a dialog assignment, the teacher clicks on the assignment control. If there is a test or quiz, students may be re-ordered and re-grouped by their performance on the assessment. For example, students might be divided into four groups. In addition, the screen displays the objective or objectives covered by the assessment and, where appropriate, makes recommendations as to which objectives might be targeted for instruction in the assignment.

The assignment screen gives the teacher the option of creating an assignment or selecting an assignment from a list of assignments linked to standards addressed in the dialog. In the event that a test or quiz has been given, assignments may be made for one or more of the groups formulated based on student performance. The teacher may preview a selected assignment, copy the assignment and edit the copy, or create one or more new assignments. If a new assignment is created or if an assignment is selected from a shared library, the assignment is recorded in assignment builder. Selected assignments are also automatically scheduled on the class calendar.

### Scheduling Dialogs as Lessons

A dialog may be scheduled as a lesson in essentially the same way that assignments are linked to dialogs. Teachers may schedule a dialog lesson by clicking on the lesson plan icon. If a test has been given, students are re-ordered and re-grouped by their test performance. The teacher has the option of creating or selecting a multi-faceted plan accommodating differential needs of the groups. For example, the teacher might provide direct instruction accommodating the needs of one group while other groups worked on in-class assignments targeted at their needs.

### Reviewing a Dialog Presentation

Dialog presentations constructed for broad dissemination can be reviewed online using the dialog review feature in present application. Two types of presentations may qualify for broad dissemination. The first is comprised of presentations developed for use by its clients. The second involves presentations developed by districts committed to sharing resources through a learning community composed of multiple districts. The review process for resources mirrors the internal review process used for item development. A review screen similar to that used for item bank construction makes it possible to review presentations constructed in-house. The status categories include: “not reviewed, accept, needs modification, and accept and certify.” There is a comment box making it possible for the reviewer to indicate needed modifications. A template of the presentation is available from the review screen.

The review process for resources constructed by districts is similar to that used for test review. Review status includes three categories: “not reviewed, accept, and needs modification.” A comment box is included to make it possible to detail recommended modifications. A two-tiered review process comprised of an initial review and a final review is available. The initial review accommodates multiple reviewers. The final review is carried out by a single reviewer responsible for accepting the presentation and indicating that it is of acceptable quality to be shared with members of a specified learning community. Accepted resources should be placed in libraries that can be accessed by all members of the learning community.

### Posting a Dialog in the Student/Parent Center

Dialogs may be posted in the online Student/Parent Center. Posting affords the opportunity to continue a dialog using asynchronous communication. For example, a student may raise questions regarding a reading and seek responses from the teacher. Likewise, the teacher may provide insights to students through communications directed to one or more individuals. The present instructional dialog technology also includes an optional forum available at the discretion of the teacher. The forum provides the opportunity for any participant to communicate with all participants in the dialog. For example, a student might post a question and another student might answer the question.

### Managing Instructional Dialogs

The present educational management system conceives of the management of instructional dialogs as a problem solving process including the following components: Setting instructional goals, making plans designed to achieve those goals, implementing plans, and evaluating goal attainment. Information obtained through the evaluation component drives decisions guiding instruction in subsequent iterations of the process. In keeping with the problem solving approach, each instructional dialog in the system is designed to promote the mastery of one or more goals (i.e. educational standards). Lesson plans and assignments specify the activities intended to promote standards mastery. Plans are implemented through dialog presentations and the completion of assignments. Assessments provide the information used to evaluate goal attainment and guide instructional decisions.

A unique feature of the present dialog technology is the system's ability to accommodate and integrate dialog management at multiple levels. This is accomplished using the dialog manager. Dialog manager enables the user to specify the number of dialogs planned for instruction during a given time period for each standard to be covered during that time period. This information can be used to guide the development of dialogs aligned to standards currently targeted for instruction in the district pacing calendar. The system provides the capability for teachers to manage dialogs providing instruction for students in their classes. It also accommodates the management of sets of dialogs linked to interventions designed for specific groups of students. In addition, the system makes it possible to manage sets of dialogs implemented by groups of teachers to achieve school or district goals.

The management process for sets of dialogs includes the same components as those involved in the management of individual dialogs by teachers. Sets of standards adopted to achieve specific goals drive the instructional process. Sets of dialogs are selected and implemented to achieve goals. Benchmark and formative assessments are used to evaluate goal attainment and to provide the data needed to guide instructional decisions.

The evaluation process may be informed not only by assessment results, but also by dialog records. Dialog records can play a particularly important role in evaluations designed to promote the effectiveness of large-scale instructional interventions. One of the major problems associated with evaluating the effects of a large-scale instructional intervention is that of determining the extent to which the planned intervention was actually implemented as intended. Dialog records provide useful information for addressing this issue. A dialog record is a record of instruction. The record includes the goals or standards targeted for instruction, student-teacher interactions during dialog presentations, student performance on dialog assignments, and results of assessments linked to the dialog. The information contained in dialog records can be used to identify instances in which an intervention was or was not implemented. In addition, dialog records can be used to estimate the fidelity of intervention implementation. For example, if an intervention is supposed to address a particular set of objectives, dialog records can be used to document whether or not dialog presentations, assignments, and formative assessments linked to dialogs actually addressed those objectives.

It is intended that the above detailed description and accompanying drawings be interpreted as only illustrative and that many modification, variations and changes in detail may be made without departing from the scope and spirit of the invention.

1. A system of online communications among students and the teacher within an educational management system comprised of:
means for integration of online interactions between students and teachers, to be included in a K-12 curriculum;
interactions including instructional elements such as lesson plans, assignments, benchmark and formative assessments;
means for forming a permanent record of instruction indicating what has been taught and learned, and providing actionable information that can inform future instruction;
means for recording the extent to which intervention has been implemented; and
means for manual and automated scheduling of online interactions, providing for real-time and asynchronous communications, and the ability to suspend interactions prior to completion.

2. The system as claimed in claim 2, further including means for constructing, reviewing, and modifying elements of the system prior to scheduling for use in a learning environment.

3. The system as claimed in claim 2 including means for a reviewer to require modification prior to approving the instructional element under review.

4. The system as claimed in claim 1 including means enabling sharing of instructional elements among a group of schools or districts.

5. The system as claimed in claim 1 including means for attaching multimedia resources and external links to instructional elements.

6. The system as claimed in claim 1 including means for enabling formative assessments, lesson plans, or assignments to be attached to a scheduled interaction at any user-determined location.

7. The system as claimed in claim 1 including a dialog manager for enabling a user to specify the number of dialogs planned for a time period for each standard to be covered during that time period.
